(19) United States
(12) Patent Application Publication
(10) Pub. No.: US 2013/0302456 A1
(43) Pub. Date: Nov. 14, 2013

(54) POWDER PRESS

(71) Applicant: Alex Wehrli, Kehrsatz (CH)

(72) Inventor: Alex Wehrli, Kehrsatz (CH)

(73) Assignee: OSTERWALDER AG, Lyss (CH)

(21) Appl. No.: 13/980,010

(22) PCT Filed: Jan. 24, 2012
(86) PCT No.: PCT/EP2012/051013

§ 371 Date: Jul. 16, 2013

(30) Foreign Application Priority Data
Jan. 24, 2011 (EP) 11151833.8

(51) Int. Cl. B30B 11/02

(52) U.S. Cl. CPC B30B 11/02
USPC 425/78; 425/150

(57) ABSTRACT

A powder press for producing a pressed piece from a powdered material, with a frame, a punch arrangement, and a die arrangement, which defines a die cavity into which the powdered material is fillable. To form the pressed piece, the punch arrangement and the die arrangement are movable relative to one another along a press stroke axis Z-Z; are pressible against each other; and one or both contains a linking element connected to two driving means, as well as a die plate and/or punch plate guided on guiding means along the stroke direction Z-Z and connected to the linking element. The driving means are each connected to the linking element by means of a flexible connecting means which lie on a first straight line X-X which is orthogonal to the press stroke axis Z-Z. The linking element is connected to the die plate or the punch plate by means of a further flexible connecting means which is disposed, in a way equidistant to the flexible connecting means, on a second straight line Y-Y orthogonal to the press stroke axis Z-Z and orthogonal to the first straight line X-X, such that the resulting forces transmitted by the further flexible connecting means are introduced into the die plate or the punch plate at a point on a vertical straight line running through the center of gravity of the die plate or respectively the punch plate.

The invention relates to a powder press for producing a pressed piece from a powdered material. Such a powder press has a frame, a punch arrangement and a die arrangement. The latter defines a die cavity into which the powdered material can be filled, after which, to form the pressed piece, the punch arrangement and the die arrangement can be moved relative to one another along a vertical press stroke axis and can be pressed against each other.

The drive of the die arrangement or of the punch arrangement takes place, as a rule, via two drives parallel to one another acting parallel to the vertical axis of the press, each with a servomotor. The two servomotors work in master slave operation in order to ensure, to a large extent, a synchronous drive movement of the two parallel drives along, or respectively parallel to, the vertical axis.

It is extremely important that the drive movement of the two parallel drives runs synchronously. Otherwise misalignments can arise of the parts of the press drivable and led along the vertical press stroke axis. Depending on type of construction of the press, this affects the die plate and/or the punch plate, which are guided along a multiplicity of vertical guides parallel to one another. If a greater difference in their travel distances would arise here between the two drives parallel to one another, the mounted tool (mounted on the die plate and/or on the punch plate) could be damaged. In the worst case, the vertical guides of the die plate and/or of the punch plate as well as the drives could be damaged.

Various measures in the area of software and electrical hardware are known here and are used successfully as preventive measures. Thus also during special types of operation and in special circumstances of the press, such as e.g. immediate stop, emergency stop, electrical power outage, the drives can be shut down in a controlled way.

Nevertheless a minimal risk remains. If, for example, the communication connection necessary for the master-slave operation between the two drive control systems is cut off, there is the risk that the two servomotors no longer work synchronously. In the worst case the two servomotors would then work against each other up until shutdown. This would almost certainly lead to considerable damage to the tool and possibly to the press.

The object of the invention is to eliminate to a large extent this remaining risk.

This object is achieved by means of a powder press for producing a pressed piece from a powdered material, with a frame, a punch arrangement and a die arrangement, which defines a die cavity into which the powdered material is fillable and afterwards the punch arrangement and the die arrangement are movable relative to one another along a vertical press stroke axis Z-Z and are pressible against one another to form the pressed piece, whereby the die arrangement and/or the punch arrangement of the powder press are designed according to the invention.

The design according to the invention of the die arrangement is characterized in that

a) the die arrangement (4) has a die plate linking element (41) connected to two drive means (9, 10) acting parallel along the vertical axis Z-Z and a die plate (42) guided along the stroke direction or respectively vertical axis Z-Z on guide means (5, 6, 7, 8) and connected to the die plate linking element (41); and

b) the die plate linking element (41) is connected to a first drive means by means of a first flexible connecting means (11; 11′) and to a second drive means (10) by means of a second flexible connecting means (12; 12′), the first connecting means (11; 11′) as well as the second connecting means (12; 12′) being disposed on a first straight line X-X orthogonal to the vertical press stroke axis Z-Z; and

c) the die plate linking element (41) and the die plate (42) are connected to one another by means of a third flexible connecting means (13; 14, 15; 13′; 14′, 15′), which is disposed on a second straight line Y-Y orthogonal to the vertical press stroke axis Z-Z and orthogonal to the first straight line X-X in a way equidistant to the first flexible connecting means (11; 11′) and the second flexible connecting means (12; 12′) in such a way that the resulting tractive force or thrusting force transmitted by the third flexible connecting means (13; 14, 15; 13′; 14′, 15′) is introduced into the die plate (42) at a point on a vertical straight line running through the center of gravity of the die plate (42),

wherein

d) on the one hand: the first flexible connecting means has a first flexible connecting element (11; 11′) fixed to the first drive means (9) and to the die plate linking element (41); and

the second flexible connecting means has a second flexible connecting element (12; 12′) fixed to the second drive means (10) and to the die plate linking element (41); and

e1) on the other hand: the third flexible connecting means has a third flexible connecting element (13; 13′) fixed to the die plate linking element (41) and to the die plate (42); or

e2) the third flexible connecting means has a third flexible connecting element (14; 14′) fixed to the die plate linking element (41) and to the die plate (42) and a fourth flexible connecting element (15; 15′) fixed to the die plate linking element (41) and to the die plate (42).

The design according to the invention of the punch arrangement is characterized in that

a′) the punch arrangement (4) has a punch plate-linking element (41) connected to two drive means (9, 10) acting parallel along the vertical axis Z-Z and a punch plate (42) guided along the stroke direction or respectively vertical axis Z-Z on guide means (5, 6, 7, 8) and connected to the punch plate-linking element (41); and

b′) the punch plate-linking element (41) is connected to a first drive means (9) by means of a first flexible connecting means (11; 11′) and to a second drive means (10) by means of a second flexible connecting means (12; 12′), the first connecting means (11; 11′) as well as the second connecting means (12; 12′) being disposed on a first straight line X-X orthogonal to the vertical press stroke axis Z-Z; and

c′) the punch plate-linking element (41) and the punch plate (42) are connected to one another by means of a third flexible connecting means (13; 14, 15; 13′; 14′, 15), which is disposed on a second straight line Y-Y orthogonal to the vertical press stroke axis Z-Z and orthogonal to the first straight line X-X in a way equidistant to the first flexible connecting means (11; 11′) and to the second flexible connecting means (12; 12′) in such a way that the resulting tractive force or thrusting force transmitted by the third flexible connecting means (13; 14, 15; 13′; 14′, 15′) is introduced into the punch plate (42) at a point on a vertical straight line running through the center of gravity of the punch plate (42),

wherein

d′) on the one hand: the first flexible connecting means has a first flexible connecting element (11; 11′) fixed to the first drive means (9) and to the punch plate linking element (41); and

the second flexible connecting means has a second flexible connecting element (12; 12′) fixed to the second drive means (10) and to the punch plate linking element (41); and

e1′) on the other hand: the third flexible connecting means has a third flexible connecting element (13; 13′) fixed to the punch plate linking element (41) and to the punch plate (42); or

e2′) the third flexible connecting means has a third flexible connecting element (14; 14′) fixed to the punch plate linking element (41) and to the punch plate (42) and a fourth flexible connecting element (15; 15′) fixed to the punch plate linking element (41) and to the punch plate (42).

Preferably both the die arrangement and the punch arrangement are designed in the way described according to the invention.

It is especially advantageous if the force transmission occurring practically only in the vertical direction takes place through the third flexible connecting means in the center of gravity of the die plate or respectively of the punch plate.

This construction according to the invention ensures that even with a difference arising for any reason between the travel distance of the first drive means extending along the press stroke axis Z-Z (e.g. vertical direction) and of the second drive means taking effect parallel thereto, the tractive force or thrusting force is registered in the die plate or respectively in the punch plate with very minimal tilting effect or practically without tilting effect.

With a powder press according to the invention, the force transmission takes place from the two parallel drives into the die plate and/or into the punch plate, depending on the construction of the press, via a die plate linking element into the die plate and/or via a punch plate linking element into the punch plate. The two parallel drives, the die plate and/or the punch plate are thus rigid structures that, owing to their geometry such as e.g. relatively thick design of the plates, reinforcement ribs on the plate, etc. as well as owing to the plate material such as e.g. steel, undergo only a minimal deformation under load effect.

In contrast thereto, the flexible connecting means, which, on the one hand, are disposed between each of the two drives and the linking element and, on the other hand, between a linking element (die plate linking element) and the die plate and/or between a linking element (punch plate linking element) and the punch plate, allow a deformation, in particular a bending of the flexible connecting means.

With deformation of the first flexible connecting means and of the second flexible connecting means, a difference between the travel distance of the first drive extending along the press stroke axis ZZ (e.g. vertical direction) and of the second drive taking effect parallel thereto can thereby be transmitted to the linking element. The linking element is thereby tilted about a rotational axis, which, on the one hand, extends orthogonally to the first straight line X-X which runs through the first flexible connecting means and through the second flexible connecting means, and, on the other hand, extends orthogonally to the stroke direction Z-Z.

The rotational axis or respectively the tilting axis of the linking element extends parallel to the second straight line Y-Y on which the third flexible connecting means is disposed equidistantly to the first flexible connecting means and to the second flexible connecting means. The tilting effect thereby transmitted from the linking element via the third flexible connecting means to the die plate or respectively to the punch plate is much smaller than the tilting effect that would be transmitted to the die plate or respectively to the punch plate if the two drives with a travel distance difference would act directly on the die plate or respectively on the punch plate.

Misalignments of the die plate and/or punch plate guided along a multiplicity of guides parallel to one another are thereby considerably reduced, whereby damage to the tool or to the guides of the die plate and/or punch plate as well as to the drives are prevented in an effective way.

The straight line X-X can be defined as the straight line along which the two drives are disposed, or, said a little more precisely, the straight line on which the points of contact lie of the first flexible connecting means and of the second flexible connecting means with the linking element. The straight line Y-Y, orthogonal to the straight line X-X, can be defined as the straight line on which or along which the third flexible connecting means is disposed, or, said a little more precisely, the straight line on which the points of contact lie of the third flexible connecting means with the die plate or respectively with the punch plate.

Preferably the positions of the first straight line X-X, of the second straight line Y-Y and of the tilting axis, parallel thereto, of the linking element in the Z direction are identical or nearly identical. The Z position of the linking element tilting axis lies, typically but not necessarily, between the Z position of the straight line X-X and the Z position of the straight line Y-Y. These measures bring about that, during tilting of the linking element as a reaction to a difference in travel distance between the two drives, the third flexible connecting means is practically not moved out of its equidistant position between the first flexible connecting means and the second flexible connecting means. Advantageously the straight line Y-Y with the third flexible connecting means and the tilting axis are disposed within a relatively small range of the Z position along the lifting axis Z-Z around the Z position of the straight line X-X. Preferably this range AZ, i.e. this Z interval, is smaller than half, but preferably smaller than a quarter, of the X distance between the first flexible connecting means and the second flexible connecting means along the straight line X-X.

Preferably the first flexible connecting means has a first flexible connecting element attached to the first drive means and to the linking element, and the second flexible connecting means has a second flexible connecting element attached to the second drive means and to the linking element.

These connecting elements can be designed pin-type, whereby they have advantageously a minimal dimension D (e.g. pin cross-section diameter or pin cross-section diagonal) transverse to the Z direction and a large dimension L (length) along the Z direction.

The connecting elements can also be designed leaf-type, whereby they have advantageously a minimal dimension D (e.g. leaf thickness) transverse to the Z direction and a large dimension L (length) along the Z direction.

Depending upon the type of material (steel, elastomer or composite material containing these materials), the connecting elements have a L/D ratio in the range of 4:1 to 15:1. The transverse dimension D of the pin-type or leaf-type connecting elements lies preferably in the range of 1/20 to ⅛ of the X distance between the first flexible connecting element and the second flexible connecting element along the straight line X-X. With the leaf-type flexible connecting elements, their smallest dimension (thickness D) is in the X direction, while their dimension in the Y direction (breadth B) can be much larger and can be even bigger than their dimension (length D) in the Z direction. Hence the leaf-type connecting elements are very flexible in the transverse direction X, while they have practically no flexibility in the transverse direction Y as well as in the longitudinal direction Z.

In a first variant, the third flexible connecting means also has a third flexible connecting element attached to the linking element and to the die plate or respectively to the punch plate, which third flexible connecting element is attached to the linking element at a central linking element attachment site 0/0/Z1 lying on the vertical axis Z-Z, and which is fixed to the die plate or respectively to the punch plate at a plate attachment site 0/0/Z2 lying on the vertical axis Z-Z. Preferably this plate attachment site is located close to the center of gravity of the die plate or respectively of the punch plate. This first variant of the configuration of the third flexible connecting means forms a “single-point flexi support/suspension” and, with respect to the typically symmetrical shape of the die plate or respectively of the punch plate, a “central flexi support/suspension”.

With this central single-point flexi support/suspension, the plate attachment site 0/0/Z2 for the die plate or the punch plate is preferably nearly or completely equidistant to the plate guides extending in the Z direction. With this measure, a tilting effect registered in the die plate and/or punch plate can be further minimized or respectively eliminated completely.

In the case of a die plate or punch plate which is guided on three vertical parallel guides that traverse a horizontal cutting plane at the corners of a fictitious equilateral triangle, this support/suspension is preferably located below, in or above the center of gravity of this fictitious triangle. Advantageously in this case the die plate or punch plate also has the symmetry of this equilateral triangle, so that the center of gravity (center of mass) of the plate coincides with the center of gravity of the fictitious triangle.

In the case of a die plate or punch plate which is guided on four vertical parallel guides (typical embodiment) that traverse a horizontal cutting plane at the corners of a fictitious square, this support/suspension is preferably located below, in or above the center of gravity of this fictitious square. Advantageously also in this case, the die plate or punch plate likewise has the symmetry of this equilateral square, so that the center of gravity (center of mass) of the plate coincides with the center of gravity of the fictitious square.

In the general case of a die plate or punch plate which is guided on N vertical parallel guides that transverse a horizontal cutting plane at the corners of a fictitious regular polygon with N edges, this support/suspension is preferably located under, in or above the center of gravity of this fictitious regular polygon with N edges. Advantageously also in this case the die plate or punch plate likewise has the symmetry of this regular polygon with N edges, so that the center of gravity (center of mass) of the plate coincides with the center of gravity of the regular polygon with N edges.

In a second variant, the third flexible connecting means also has a third flexible connecting element attached to the linking element and to the die plate or respectively to the punch plate and a fourth flexible connecting element, which are attached to the linking element at a first linking element attachment site 0/Y4/Z1 or respectively at a second linking element attachment site 0/Y5/Z1 and which are attached to the die plate or respectively punch plate at a first plate attachment site 0/Y4/Z2 or respectively at a second plate attachment site 0/Y5/Z2, the linking element attachment sites 0/Y4/Z1 and 0/Y5/Z1 lying on a first straight line orthogonal to the vertical axis Z-Z, and the plate attachment sites 0/Y4/Z2 and 0/Y5/Z2 lying of a second straight line orthogonal to the vertical axis Z-Z and parallel to the first straight line. Preferably these plate attachment sites are located near the center of gravity of the die plate or respectively of the punch plate, i.e. the second straight line with the plate attachment sites runs near the center of gravity of the plate or through the plate center of gravity. This second variant of the configuration of the third flexible connecting means forms a “multi-point flexi support/suspension” with decentralized, linearly distributed support/suspension points.

This second variant is suitable for die plates or punch plates which is <sic are> guided on four vertical parallel guides (typical embodiment) that transverse a horizontal cutting plane at the corners of a fictitious square or rectangle. This rectilinearly distributed support/suspension thereby preferably runs parallel under, congruently with, or over a line of symmetry running through the center of gravity of this fictitious square or rectangle. Advantageously also in this case the die plate or punch plate likewise has the symmetry of this square or rectangle, so that the center of gravity or respectively the line of symmetry of the plate coincides with the center of gravity or respectively the line of symmetry of the fictitious square or rectangle.

The flexible connecting means are preferably rigid in the direction of the force transmission during a pressing action, i.e. along the stroke axis Z-Z, whereas they are flexible in a direction orthogonal to the stroke axis Z-Z. Thus during the pressing action the forces acting along the stroke axis Z-Z can be transmitted from the two drives via the first flexible connecting means and the second flexible connecting means to the linking element and from this element via the third flexible connecting means (variant 1: single-point flexi support/suspension; or variant 2: multi-point flexi support/suspension) to the die plate or to the punch plate. This mechanical drive line along the stroke axis Z-Z is very rigid, while the flexibility of the connecting means on both sides of the preferably rigid linking element enables a tilting of the linking element, whereby a travel distance difference between the two drives is compensated and is kept away from the die plate or the punch plate.

With an advantageous embodiment of the powder press, one or both of the flexible connecting elements between the drives and the linking elements are formed in each case by a pin-type or leaf-type element elastically tensioned parallel to the vertical axis Z-Z, which pin-type or leaf-type element extends through a respective through hole of the linking element, a first end of the respective pin-type or leaf-type element being connected to a respective drive means and a second end of the respective pin-type or leaf-type element being connected to the linking element.

Preferably one or both of the flexible connecting elements are each a screw/spacer unit, whose respective spacer is clamped between the facing sides of the respective drive means and of the linking element by means of the respective screw, the respective screw extending through the respective through hole of the linking element and being surrounded by the respective spacer in a ring-like or sleeve-like way, preferably a first end of the respective screw being screwed into a threaded bore of the respective drive means and a second end, designed as screw head, of the respective screw abutting the linking element in the region of the through hole.

The spacer can be of varying design, such as e.g. sleeve-type, designed in particular as a sleeve or as a spiral spring, or ring-type, designed in particular as a flat annular disk or as disk spring (frustum). Preferably on its two ends, by means of which it abuts the respective drive means and abuts the linking element, the spacer has one flange-like front abutment face each.

The sleeve-type spacer and the disk spring preferably consist of a material with high elastic modulus, such as e.g. steel. The flat annular disk can consist of a material with high elastic modulus, e.g. steel, or of a material with small elastic modulus, e.g. elastomer.

The function of the spacer and of the flexibility can be achieved through a combination of the mentioned ring-type and sleeve-type spacers by a certain combination of such spacers being put over the threaded section of the screw and then stacked, and finally compressed by screwing in of the screw, and thus pretensioned. Thus the hardness and thereby the flexibility of the thus resultant assembled spacer (composite spacer) can be adjusted both through the type of combination as well as through the amount of compression of the one or more spacers.

In an alternative or supplementary way, one or both of the flexible connection elements can be made up in each case of a spring leaf unit, whose respective spring leaf, which is a leaf-type spacer, extends in a plane orthogonal to the first straight line X-X, a first end of the respective spring leaf being firmly connected to the respective drive means e.g. by means of a first clamping member unit, and a second end of the respective spring leaf being firmly connected to the linking element e.g. by means of a second clamping member unit.

The first clamping member unit and the second clamping member unit preferably each contain two clamping strips, which can be fixed to the drive means or respectively to the linking element e.g. by screws, a clamping gap being formed in each case for receiving one of the two edges of the spring leaf. Firmly clamped between the respective two clamping strips is one of the two edges of the spring leaf. For this purpose through holes are preferably provided in the two clamping strips and in the spring leaf to be clamped, which holes line up with respect to one another, with spring leaf inserted in the clamping gap, and are able to be fixed by means of a screw/nut configuration extending through these through holes. The spring leaf thereby fits tightly in a frictionally engaged and formfitting way in the clamping gap between the two clamping strips.

Here too the function of the spacer and of the flexibility can be achieved through combination of the mentioned leaf-type spacers or respectively spring leaves in that a particular combination of such spacers or respectively spring leaves are fixed lying against each other in the clamping gap, as described above. The hardness and thereby the flexibility of the thereby resultant assembled spring leaf-spacer (composite spacer) can thus be adjusted here too through the type of combination of the multiplicity of spring leaf spacers arranged in parallel.

In another advantageous embodiment of the powder press, one or both of the flexible connecting elements are spherically borne at least at one of their ends. In addition to the movement possibilities of the linking element with respect to the drive means and to the die plate, or respectively punch plate, achieved through the flexibility of the connecting elements, there results thereby a further movement possibility through a relative movement between two abutting spherical surface sections in the spherical bearing. It is thereby especially advantageous when the spherical bearing is coupled with an elastic resetting means, which, in its neutral torque-free position, holds the linking element in a non-tilted position.

In an alternative or supplementary way, one or both of the flexible connecting elements can be cylindrically borne at least at one of their ends, the cylinder axis or respectively rotational axis of the bearing extending parallel to the straight line Y-Y. In addition to the movement possibilities of the linking element with respect to the drive means and to the die plate, or respectively punch plate, achieved through the flexibility of the connecting elements, there results thereby a further movement possibility through a relative movement between two abutting cylindrical surface sections in the cylindrical bearing. It is especially advantageous here too when the cylindrical bearing is coupled with an elastic resetting means, which, in its neutral torque-free position, holds the linking element in a non-tilted position.

While the spherical bearing makes possible two spatial degrees of freedom of the connecting element-relative movement with respect to the drive means, with respect to the linking element or with respect to the die plate or punch plate, the cylindrical bearing allows only one spatial degree of freedom of this connecting element-relative movement. The cylindrical bearing is therefore especially well suited in combination with a leaf-type flexible connecting element.

Suchlike also applies correspondingly for the third flexible connecting means (e.g. with a third flexible connecting element according to a first configuration or e.g. with a third and a fourth flexible connecting element according to a second configuration) as applies for the first flexible connecting means (e.g. with a first flexible connecting element) and the second flexible connecting means (e.g. with a second flexible connecting element).

In an advantageous embodiment of the powder press, the one or both of the further flexible connecting elements are each formed by a pin-type or leaf-type element elastically tensioned parallel to the vertical axis Z-Z, which pin-type or leaf-type element extends through a respective through hole in the die plate or respectively in the punch plate, a first end of the respective pin-type or leaf-type element being connected to the linking element and a second end of the respective pin-type or leaf-type element being connected to the die plate or respectively punch plate.

Preferably one or both of the further flexible connecting elements are each a screw/spacer unit, whose respective spacer is clamped between the facing sides of the die plate or respectively of the punch plate and of the linking element by means of the respective screw, the respective screw extending through the respective through hole of the die plate or respectively of the punch plate and being surrounded by the respective spacer in a ring-like or sleeve-like way, preferably a first end of the respective screw being screwed into a threaded bore of the linking element and a second end, designed as screw head, of the respective screw abutting the die plate or respectively the punch plate in the region of the through hole.

Here too the spacer can be of differing design, such as e.g. sleeve-type, in particular designed as sleeve or spiral spring, or ring-type, in particular designed as flat annular disk or as disk spring (frustum). Preferably on its two ends, by means of which it abuts the respective drive means and abuts the linking element, the spacer has one flange-like front abutment face each.

The sleeve-type spacer and the disk spring preferably likewise consist of a material with high elastic modulus, such as e.g. steel, while the flat annular disk can consist of a material with high elastic modulus, e.g. steel, or of a material with small elastic modulus, e.g. elastomer.

Here too the function of the spacer and of the flexibility can be achieved through a combination of the mentioned ring-type and sleeve-type spacers in that a certain combination of such spacers is put over the threaded section of the screw and then stacked, and finally compressed by screwing in of the screw, and thereby pretensioned. Thus here too the hardness and thereby the flexibility of the thus resultant assembled spacer (composite spacer) can be adjusted both through the type of combination as well as through the amount of compression of the one or more spacers.

In an alternative or supplementary way, the one or both further flexible connection elements can each be formed by a leaf spring/clamping member unit whose respective spring leaf, which is a leaf-type spacer, extends in a plane orthogonal to the first straight line X-X, a first end of the respective spring leaf being firmly connected to the linking element by means of a first clamping member unit and a second end of the respective spring leaf being firmly connected to the die plate or respectively to the punch plate by means of a second clamping member unit.

Here too the first clamping member unit and the second clamping member unit preferably each contain two clamping strips which can be fixed on the drive means or respectively on the linking element e.g. by screws, a clamping gap being formed in each case for receiving one of the two edges of the spring leaf. Firmly clamped between the respective two clamping strips is one of the two edges of the spring leaf. Preferably through holes are provided here too for this purpose in the two clamping strips and in the spring leaf to be clamped, which holes line up with respect to one another, with spring leaf inserted in the clamping gap, and are able to be fixed by means of a screw/nut configuration extending through these through holes. The spring leaf thereby fits tightly in a frictionally engaged and formfitting way also here in the clamping gap between the two clamping strips.

Here too the function of the spacer and of the flexibility can be achieved through combination of the mentioned leaf-type spacers or respectively spring leaves in that a particular combination of such spacers or respectively spring leaves are fixed lying against each other in the clamping gap, as described above. The hardness and thereby the flexibility of the thereby resultant assembled spring leaf-spacer (composite spacer) can thus be adjusted here too through the type of combination of the multiplicity of spring leaf spacers arranged in parallel.

In another advantageous embodiment of the powder press, one or both of the further flexible connecting elements are spherically borne at least at one of their ends. In addition to the movement possibilities of the linking element with respect to the drive means and to the die plate, or respectively punch plate, achieved through the flexibility of the connecting elements, there thereby results here too a further movement possibility through a relative movement between the two abutting spherical surface sections in the spherical bearing. Here too it is thereby especially advantageous when the spherical bearing is coupled with an elastic resetting means, which, in its neutral torque-free position, holds the linking element in a non-tilted position.

In an alternative or supplementary way, one or both of the further flexible connecting elements can here too be cylindrically borne at least at one or their ends, the cylinder axis or respectively rotational axis of the bearing extending parallel to the straight line Y-Y. In addition to the movement possibilities of the linking element with respect to the drive means and to the die plate, or respectively punch plate, achieved through the flexibility of the connecting elements, there results thereby here too a further movement possibility through a relative movement between two abutting cylindrical surface sections in the cylindrical bearing. It is especially advantageous here too when the cylindrical bearing is coupled with an elastic resetting means, which, in its neutral torque-free position, holds the linking element in a non-tilted position. Also here the cylindrical bearing is especially well suited in combination with a leaf-type flexible connecting element.

In an especially advantageous embodiment of the powder press, the stiffness or respectively the flexibility of the flexible connecting means are adjustable. This adjustability of the flexibility is achieved through a combination of individual components of a respective flexible connecting element, as has been described further above with reference to the ring-type or sleeve-type flexible spacer or with reference to the leaf-type flexible spacer. A further adjustability is achieved in that, in addition, the one or both ends of one or more flexible connecting elements is spherically or cylindrically suspended and is provided with an elastic resetting means, as has been likewise described further above.

In the powder press, one or more of the flexible connecting elements can each have a pin-type element, with a first pin end and a second pin end, as well as a sleeve-type element surrounding the pin-type element at least along a portion of its length between the two pin ends and along a portion of its circumferential direction. In particular the pin-type element and the sleeve-type element can thereby have a tapered region on their surfaces facing one another.

One or more of the flexible connecting elements can be made of steel, whereby preferably the interim piece and the die plate or respectively punch plate are also made of steel.

One or more of the flexible connecting elements can have a thin-walled material with a wall thickness in the range of 2 mm to 10 mm, preferably 3 mm to 6 mm, the interim piece and the die plate or respectively punch plate having preferably a thick-walled material with a sheet thickness or respectively wall thickness in the range of 20 mm to 300 mm.

One or more of the flexible connecting elements can be composed of a multiplicity of thin-walled layers of an elastic material, while the interim piece and the die plate or respectively punch plate consist of a single-piece material block.

One or more of the flexible connecting elements can also be designed as composite bodies having abutting alternating layers, of a polymer material or respectively of a metal material, extending along the longitudinal direction of the connecting element between its first end and its second end.

Further advantages, features and application possibilities of the invention follow from the description, which now follows and is not to be interpreted in a limiting way, of the preferred embodiments of the invention with reference to the drawing. Shown are:

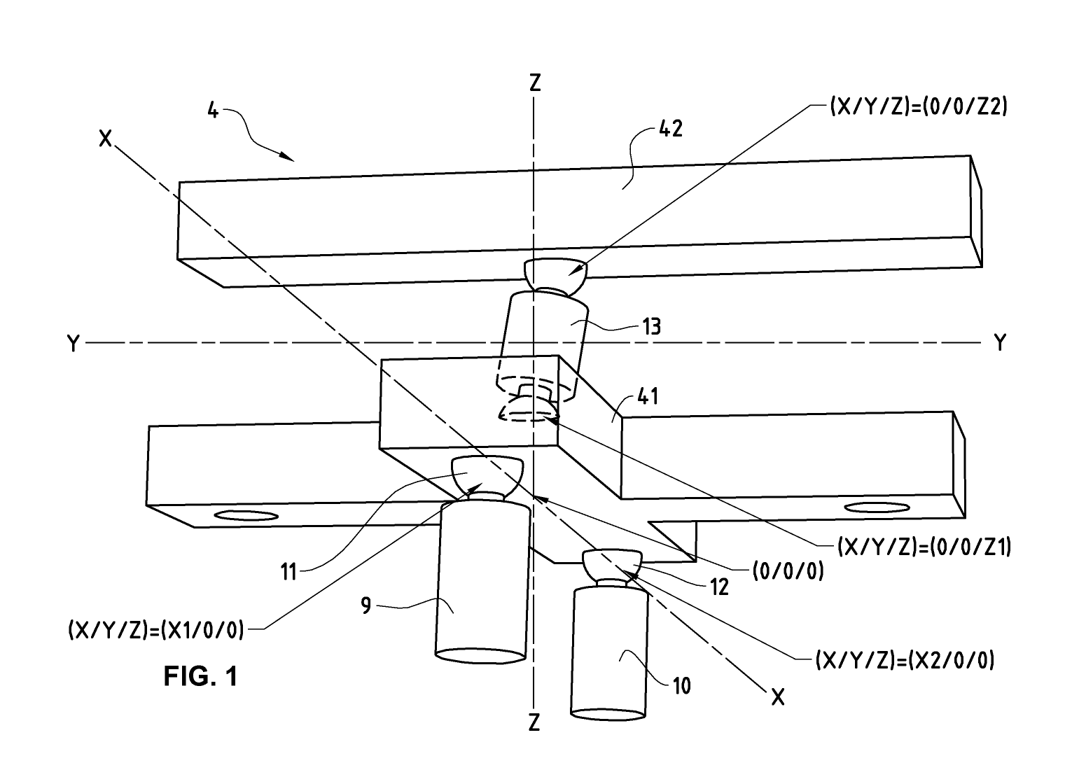

FIG. 1, a perspective view of a first configuration (die device or respectively punch device) of schematically shown invention-relevant elements of a power press according to the invention;

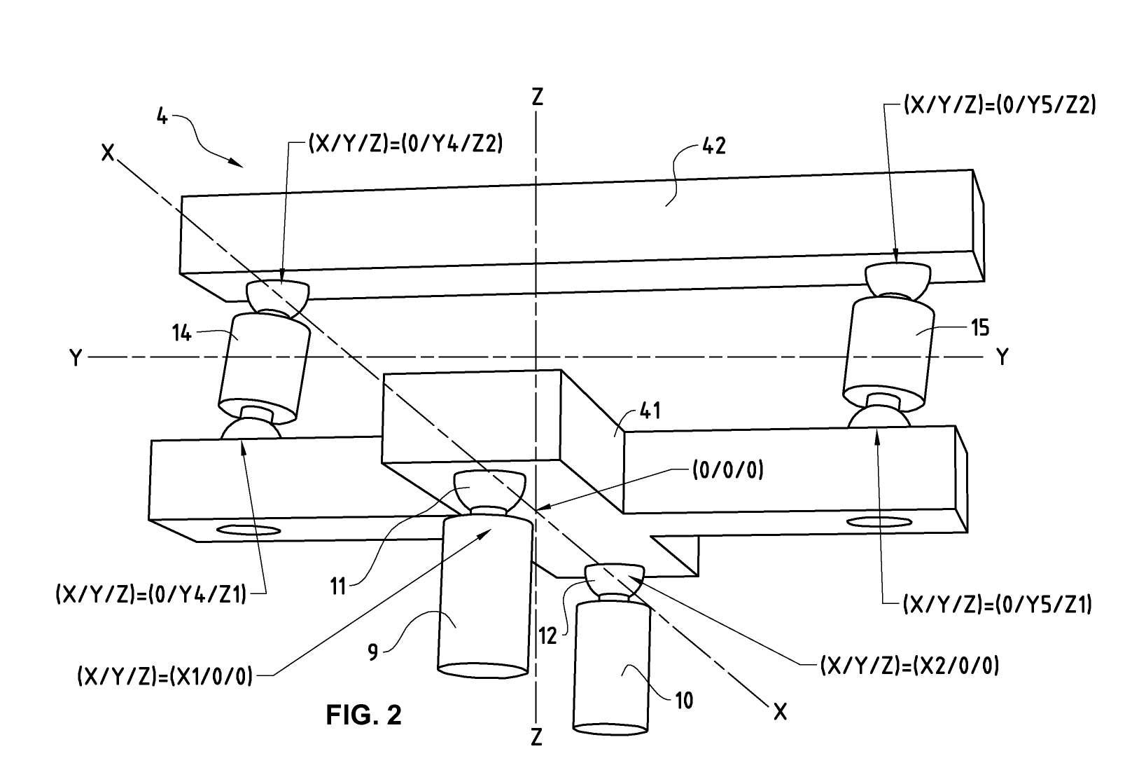

FIG. 2, a perspective view of a second configuration (die device or respectively punch device) of schematically shown invention-relevant elements of a powder press according to the invention;

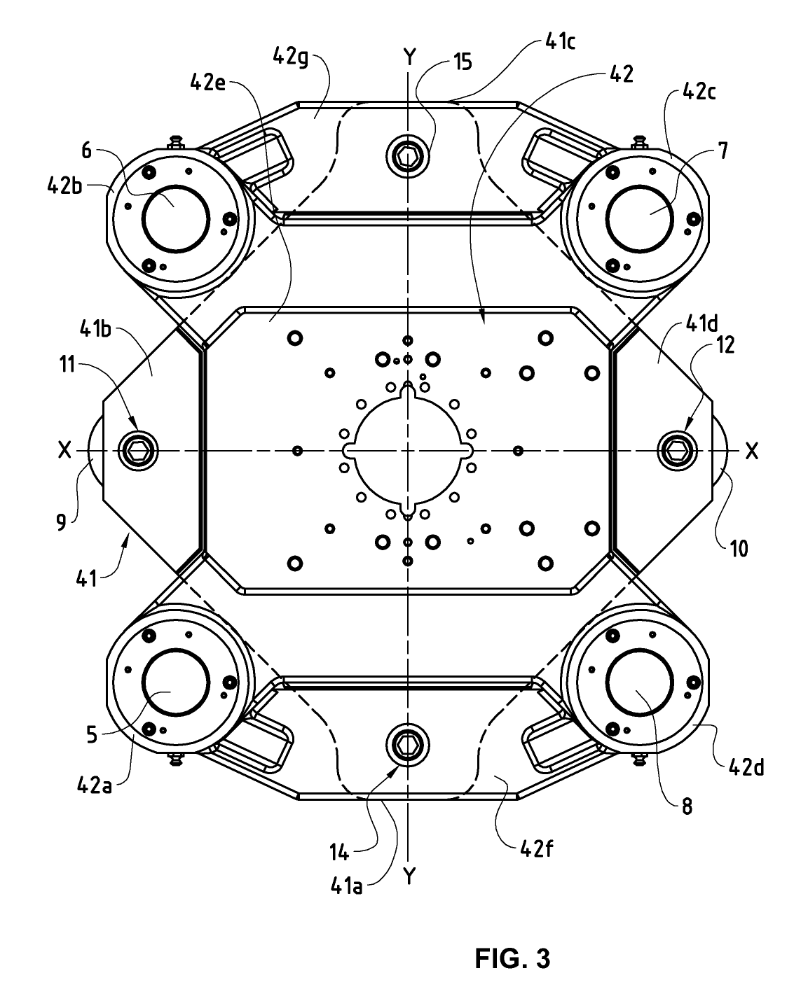

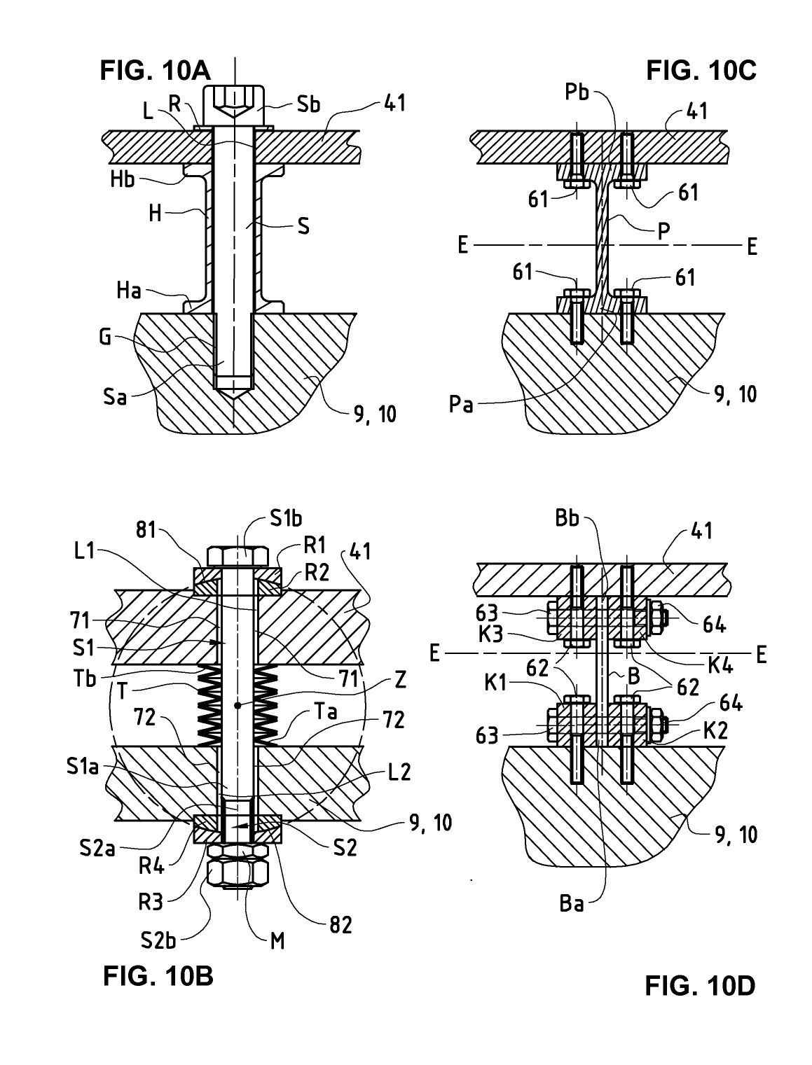

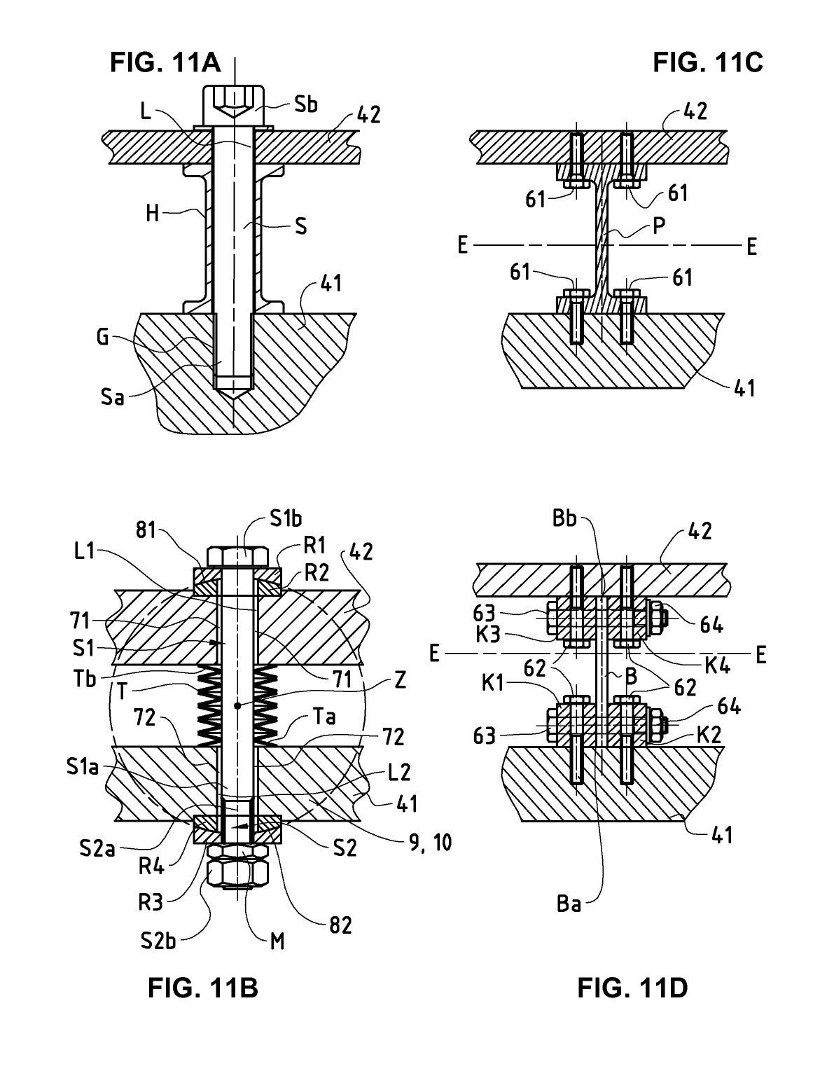

FIG. 3, a view from above along the direction Z-Z (see FIG. 2) of the elements, shown in more detail, of the second configuration according to a first embodiment (see FIG. 10A, FIG. 11A or respectively FIG. 10B, FIG. 11B);

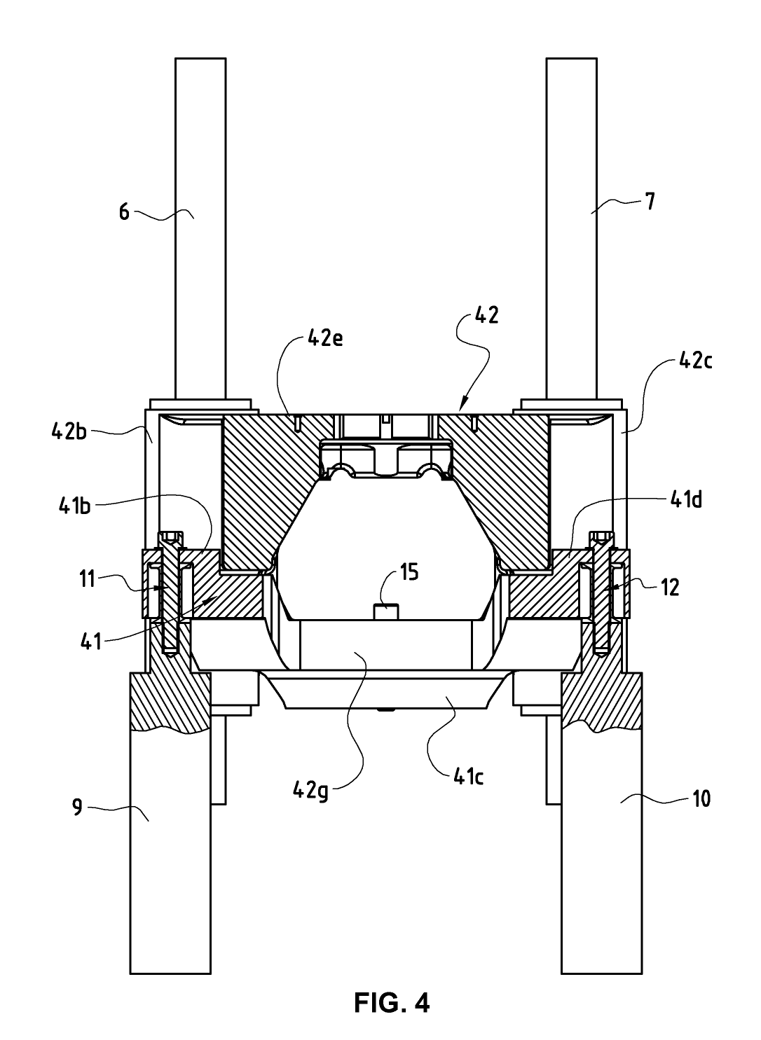

FIG. 4, a lateral view in direction Y-Y (see FIG. 3) of the elements of the second configuration according to the first embodiment, which elements are cut along a vertical plane running through the straight line X-X (see FIG. 3);

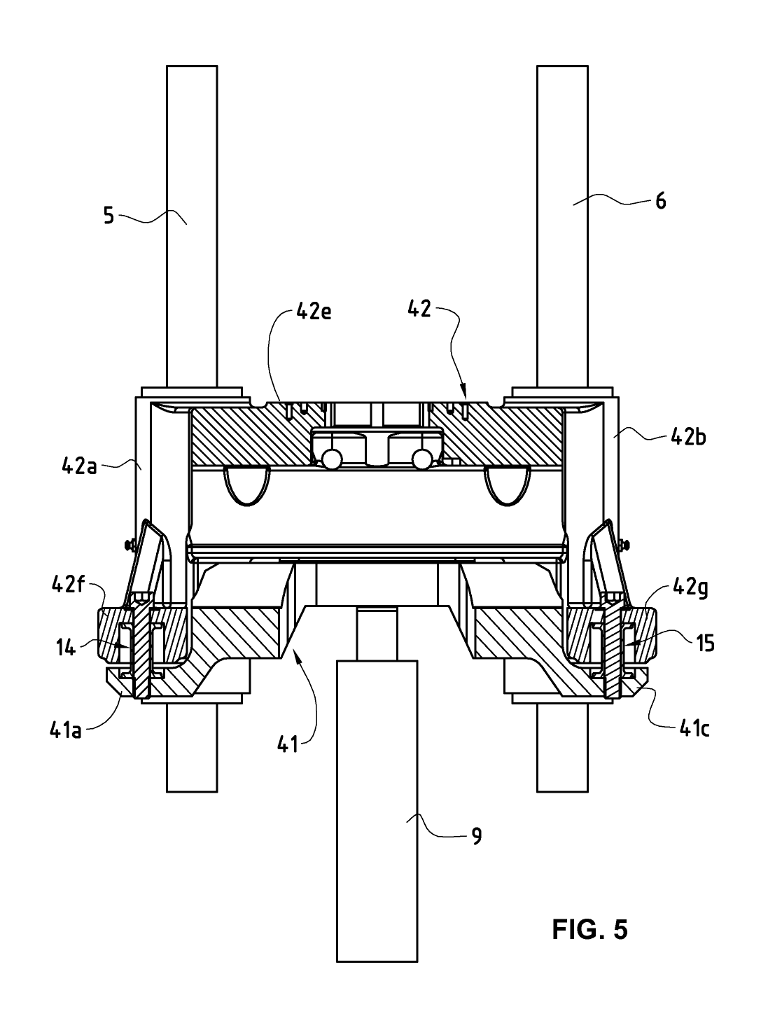

FIG. 5, a lateral view in direction X-X (see FIG. 3) of the elements of the second configuration according to the first embodiment, which elements are cut along a vertical plane running through the straight line Y-Y (see FIG. 3);

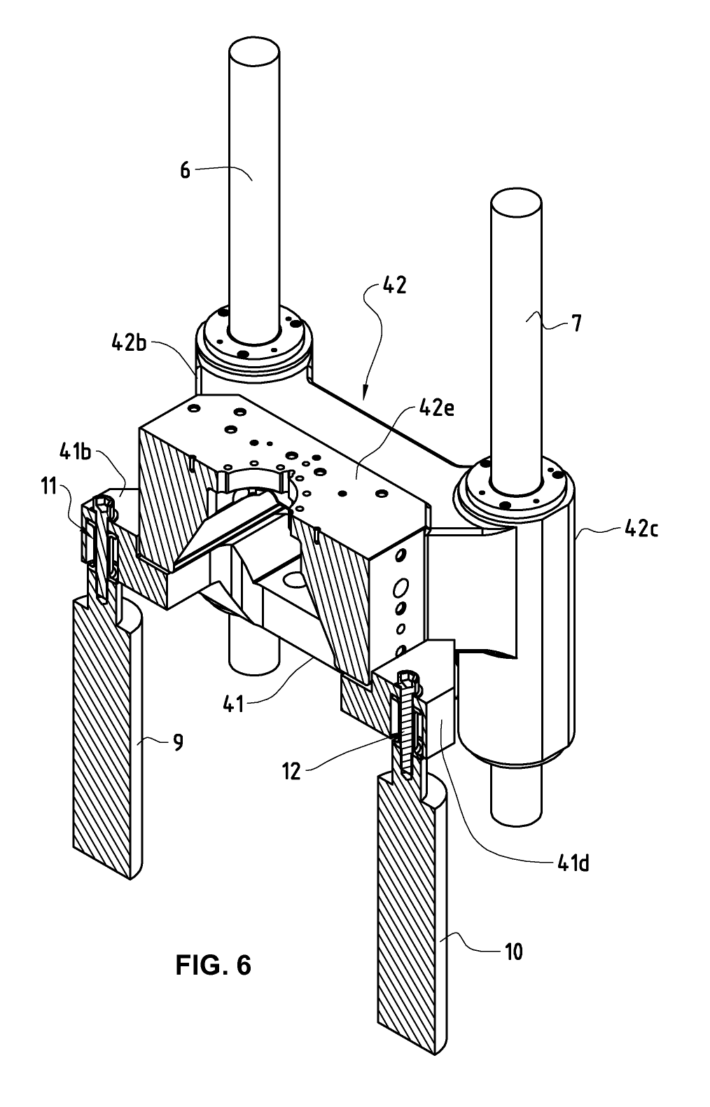

FIG. 6, a perspective view of the elements cut according to FIG. 4;

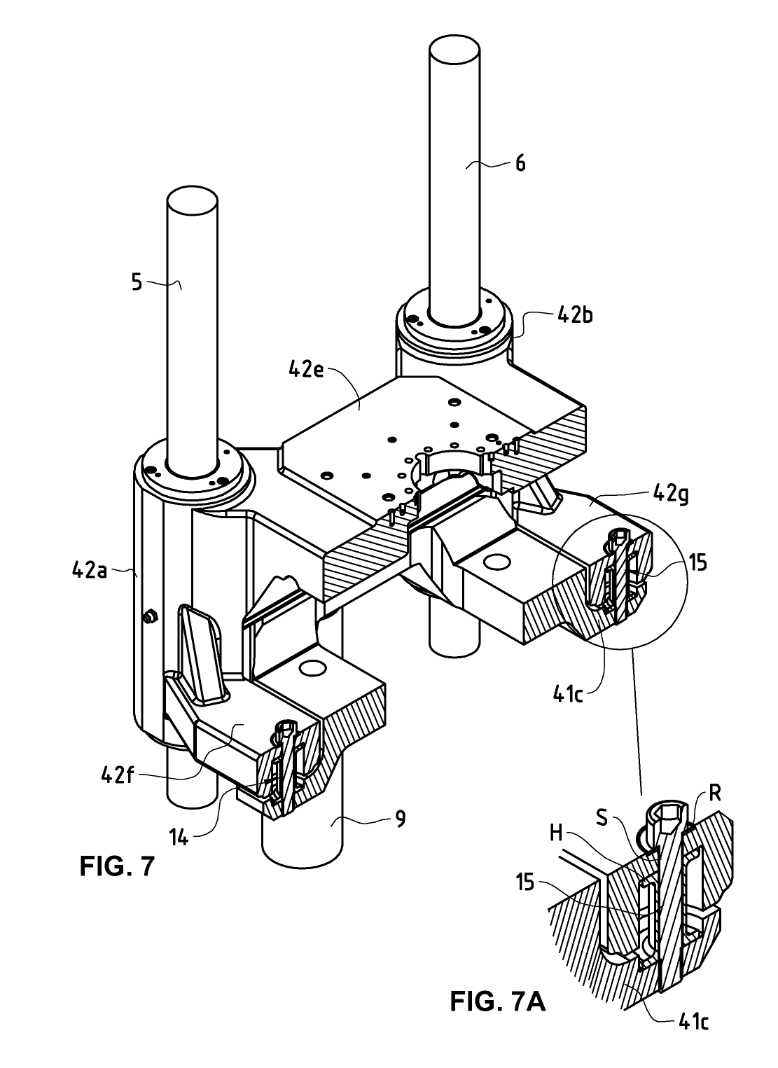

FIG. 7, a perspective view of the elements cut according to FIG. 5;

FIG. 7A, an enlarged representation of the encircled section of FIG. 7;

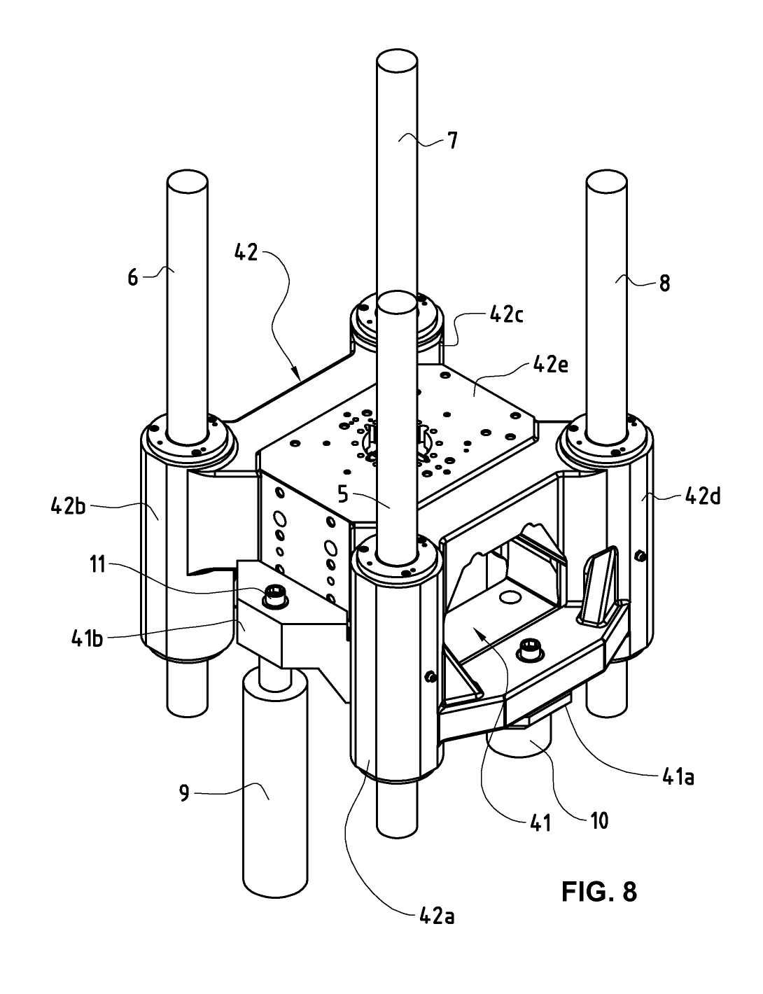

FIG. 8, a perspective view of the elements shown according to FIG. 3;

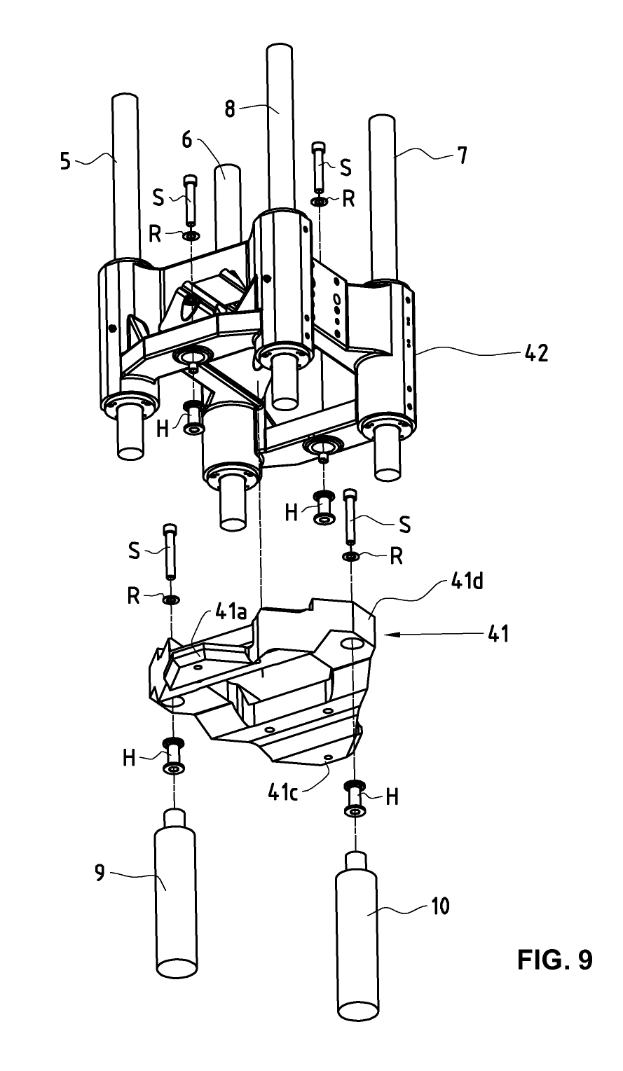

FIG. 9, a perspective, exploded view of the elements shown in FIG. 3 to FIG. 8;

FIG. 10A and FIG. 11A, a vertical section of a connecting element, shown in more detail, according to a first variant of the first embodiment, which is installed in a first region of the configuration or respectively in a second region of the configuration;

FIG. 10B and FIG. 11B, a vertical section of a connecting element, shown in more detail, according to a second variant of the first embodiment, which is installed in a first region of the configuration or respectively in a second region of the configuration;

FIG. 10C and FIG. 11C, a vertical section of a connecting element, shown in more detail, according to a first variant of a second embodiment, which is installed in a first region of the configuration or respectively in a second region of the configuration;

FIG. 10D and FIG. 11D, a vertical section of a connecting element, shown in more detail, according to a second variant of a second embodiment, which is installed in a first region of the configuration or respectively in a second region of the configuration; and

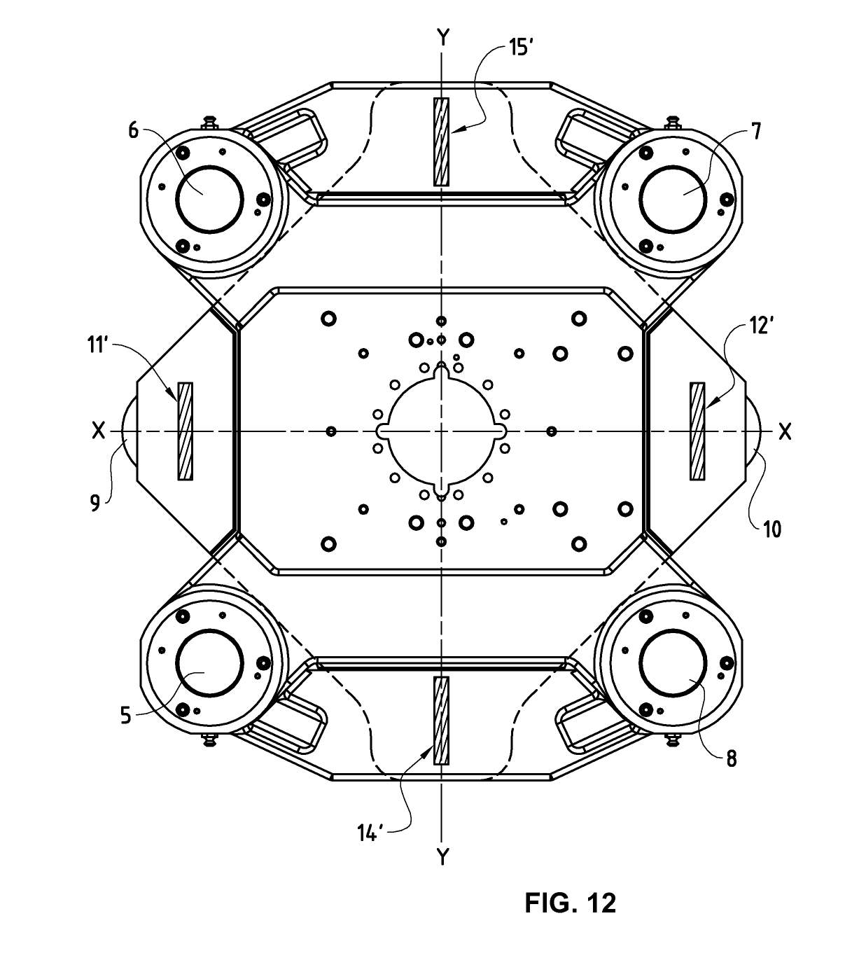

FIG. 12, a view from above, similar to FIG. 3, of the elements, shown in more detail, of the second configuration according to the second embodiment (see FIG. 10C, FIG. 11C or respectively FIG. 10D, FIG. 11D), the respective connecting elements being shown cut along a horizontal plane E-E.

Shown in FIG. 1 is a perspective view of a first configuration of the invention-relevant elements 9, 10, 11, 12, 13, 41, 42 of a powder press according to the invention. This schematic configuration 4 relates both to a die arrangement 4 according to the invention and to a punch arrangement 4 according to the invention.

This first configuration 4 according to FIG. 1 corresponds to the variant e1), described further above, in which the third flexible connecting means has one, preferably just one, third flexible connecting element 13 or 13′ fixed to the die plate linking element 41 and to the die plate 42.

This first configuration 4 according to FIG. 1 also corresponds to the variant e1′), described further above, in which the third flexible connecting means has one, preferably just one, third flexible connecting element 13 or 13′ fixed to the punch plate-linking element 41 and to the punch plate 42.

Shown in FIG. 2 is a perspective view of a second configuration of invention-relevant elements 9, 10, 11, 12, 14, 15, 41, 42 of a powder press according to the invention. This schematic configuration 4 relates both to a die arrangement 4 according to the invention and to a punch arrangement 4 according to the invention.

This second configuration 4 according to FIG. 2 corresponds to the variant e2), described further above, in which the third flexible connecting means has a third flexible connecting element 14 or 14′ fixed to the die plate linking element 41 and to the die plate 42 and a fourth flexible connecting element 15 or 15′ fixed to the die plate linking element 41 and to the die plate 42.

This second configuration 4 according to FIG. 2 also corresponds to the variant e2′), described further above, in which the third flexible connecting means has a third flexible connecting element 14 or 14′ fixed to the punch plate-linking element 41 and to the punch plate 42 and a fourth flexible connecting element 15 or 15′ fixed to the punch plate-linking element 41 and to the punch plate 42.

FIG. 1 and FIG. 2 are schematic representations for illustration of the functional principle of the invention.

The powder press contains a frame, a punch arrangement and a die arrangement, defining a die cavity into which the powdered material is fillable. These parts of the powder press are not shown in FIG. 1 and in FIG. 2. To form a pressed piece from a powdered material, the punch arrangement and the die arrangement can be moved along the vertical press stroke axis Z-Z relative to one another and can be pressed against one another.

In the following the two terms “linking element 41” and “die plate-linking element 41” will be used interchangeably. Likewise the two terms “linking element 41” and “punch plate-linking element 41” will be used interchangeably.

Moreover that said for a die plate 42 applies in an analogous way for a punch plate 42, and vice versa.

The first configuration shown in FIG. 1 contains essentially a die arrangement 4 with a die plate 42 or respectively a punch arrangement 4 with a punch plate 42, a first drive means 9 and a second drive means 10 as well as a linking element 41. The die plate or respectively punch plate 42 is guided on guide means (not shown in FIG. 1) along the stroke direction or respectively vertical axis Z-Z.

Disposed between the first drive means 9 and the linking element 41 is a first flexible connecting element 11, which can transmit thrusting forces and tractive forces along the stroke direction Z-Z between the first driving means 9 and the linking element 41. Disposed between the second driving means 10 and the linking element 41 is moreover a second flexible connecting element 12, which can transmit thrusting forces and tractive forces along the stroke direction between the second driving means 10 and the linking element 41. The two flexible connecting elements 11 and 12 define a first straight line X-X. Also more than two such point-like flexible connecting elements can be disposed along this straight line X-X.

Disposed between the linking element 41 and the die plate 42 is a third flexible connecting means 13, which can transmit thrusting forces and tractive forces along the stroke direction Z-Z between the linking element 41 and the die plate 42, the resulting force of the thrusting forces and tractive forces transmitted by the flexible connecting means 13 being conducted practically torque-free along the stroke direction Z-Z into the die plate 42. The third flexible connecting means 13 is designed for this purpose as third flexible connecting element 13, which is disposed at a place on the straight line Z-Z equidistant from the site of the first flexible connecting element 11 and from the site of the second flexible connecting element 12.

If the point of intersection of the straight line X-X with the straight line Z-Z is defined as the zero point (0/0/0) of a right-angled coordinate system (X/Y/Z), then this third flexible connecting element 13 is located at a place on the Z axis, and is attached to the linking element 41 at a linking element attachment site (0/0/Z1), and is attached to the die plate 42 at a plate attachment site (0/0/Z2). Thus the dimension of the third flexible connecting element 13 in the Z direction is ΔZ=|Z2−Z1|.

Measured in these coordinates, the first driving means 9 is attached to the linking element 41 at a linking element attachment site (X1/0/0), and the second driving means 10 is attached to the linking element 41 at a linking element attachment site (X2/0/0), these two linking element attachment sites being disposed symmetrically with respect to the stroke axis Z-Z, i.e. X2=−X1.

The first configuration described here represents a central, punctiform single-point flexi support of the die plate 42. The term “central” is thereby to be understood in such a way that the force transmission into the die plate 42 takes place via the third connecting means 13 in a torque-free way, so that also at the guides of the die plate 42 (see e.g. 5, 6, 7, 8 in FIG. 8) no torsional moments are registered by the die plate 42.

The second configuration shown in FIG. 2 is constructed in a way similar to the first configuration of FIG. 1, and contains essentially the die arrangement 4 with the die plate 42 or respectively the punch arrangement 4 with the punch plate 42, the first driving means 9 and the second driving means 10 as well as the linking element 41. The die plate 42 is likewise guided on guide means (not shown in FIG. 1) along the stroke direction or respectively vertical axis Z-Z.

Disposed between the first driving means 9 and the linking element 41 is the first flexible connecting element 11, which can transmit thrusting forces and tractive forces along the stroke direction Z-Z between the first driving means 9 and the linking element 41. Disposed between the second driving means 10 and the linking element 41 is the second flexible connecting element 12, which can transmit thrusting forces and tractive forces along the stroke direction Z-Z between the second driving means 10 and the linking element 41. The two flexible connecting elements 11 and 12 also define the first straight line X-X, and also here more than two such point-like flexible connecting elements can be disposed along this straight line X-X.

Disposed between the linking element 41 and the die plate 42 is also a third flexible connecting means 13, which can transmit thrusting forces and tractive forces along the stroke direction Z-Z between the linking element 41 and the die plate 42, here too the resulting force of the thrusting forces and tractive forces transmitted by the flexible connecting means 13 being conducted in a practically torque-free way along the stroke direction Z-Z into the die plate 42. Unlike in the case of the first configuration shown in FIG. 1, with this second configuration the third flexible connecting means 13 for this purpose is designed as third flexible connecting element 14 and fourth flexible connecting element 15, which are disposed, spaced apart from one another, at places, symmetrical to the stroke axis Z-Z, on a second straight line Y-Y, which extends orthogonally to the first straight line X-X and orthogonally to the stroke axis Z-Z. The third connecting element 14 and the fourth connecting element 15 are each disposed at a place on the second straight line Y-Y in each case equidistant from the place of the first flexible connecting element 11 and from the place of the second flexible connecting element 12.

If again the point of intersection of the straight line X-X with the straight line Z-Z is defined as the zero point (0/0/0) of a right-angled coordinate system (X/Y/Z), then the third flexible connecting element 14 is located at a place on the Y axis and is attached to the linking element 41 at a linking element attachment site (0/Y4/Z1) and to the die plate 42 at a plate attachment site (0/Y4/Z2), and the fourth flexible connecting element 15 is located at a second place on the Y axis, and is attached to the linking element 41 at a linking element attachment site (0/Y5/Z1) and to the die plate 42 at a plate attachment site (0/Y5/Z2). The dimension of the third flexible connecting element 14 and of the fourth flexible connecting element 15 in the Z direction is therefore ΔZ=|Z2−Z1|.

Measured in these coordinates, the third connecting element 14 and the fourth connecting element 15 are disposed symmetrically with respect to the stroke axis Z-Z, i.e. Y5=−Y4.

Here too the first driving means 9 is fixed to the linking element 41 at a linking element attachment site (X1/0/0), and the second driving means 10 is fixed to the linking element 41 at a linking element attachment site (X2/0/0), these two linking element attachment sites being disposed symmetrically to the stroke axis Z-Z, i.e. X2=−X1.

The second configuration described here represents a decentralized, linearly distributed multipoint flexi support of the die plate 42. The term “decentralized” is thereby to be understood in such a way that the force transmission into the die plate 42 takes place via the third connecting means 13, 14 in a torque-free way, so that also at the guides of the die plate 42 (see e.g. 5, 6, 7, 8 in FIG. 8) no torsional moments are registered by the die plate 42.

The third connecting means 13 of the first configuration (with a central connecting element 13 on the stroke axis Z-Z) can also be put together in combination with the third connecting means 14, 15 of the second configuration (with two decentralized connecting elements 14, 15 disposed symmetrically with respect to the stroke axis Z-Z), so that a third configuration results (not shown), which has a third flexible connecting means 13, 14, 15 that is made up of a third connecting element 13, a fourth connecting element 14 and a fifth connecting element 15, the third flexible connecting element 13 being disposed at a place (0/0/Z*) on the Z axis and the fourth connecting element 14 and the fifth connecting element 15 being disposed symmetrically to the stroke axis Z-Z at a place (0/Y4/Z*) or respectively at a place (0/Y5/Z*), whereby Y5=−Y4.

Shown in various diagrams in FIG. 3 to FIG. 9 is a first embodiment (pin formation) of the second configuration described further above.

In the view from above of FIG. 3, the die plate 42 can be seen, which has an approximately rectangular outline. The die plate 42 has at four diametrally opposed corner regions of rectangular-like outline one sleeve-type formation each 42a, 42b, 42c, 42d with in each case a central bore, whose cylinder axis runs in each case parallel to the stroke axis Z-Z. On its upper side the die plate 42 has a substantially flat surface 42e, on which application-specific tools can be mounted. For this purpose numerous mounting holes are provided in the surface 42e. By means of the four cylindrical bores in the four sleeve-type formations 42a, 42b, 42c, 42d, the die plate 42 is borne on four cylindrical guides 5, 6, 7, 8, as can be best seen in FIG. 8. These guides 5, 6, 7, 8 extend parallel to one another in the Z direction parallel to the stroke axis Z-Z. The die plate 42 is thereby displaceable along the stroke axis Z-Z.

In the view from above of FIG. 3 the linking element 41 can also be discerned, which is disposed below the die plate 42 and is partially covered thereby. In the covered region the contour of the linking element 41 is shown with a broken line. The linking element 41 has in its top plan view contour four convex areas 41a, 41b, 41c, 41d, which each have a vertical through hole or respectively a vertical bore. Extending into this vertical through hole and there-through is, respectively, one of four connecting elements 11, 12, 14, 15.

The location of the connecting element 11 and of the connecting element 12 in the top plan view lie on a first straight line X-X extending in the horizontal direction, i.e. orthogonally to the stroke axis Z-Z. The connecting element 11 extends through the vertical hole of the convex area 41b of the linking element 41, and is attached by its lower end to the driving means 9, as can be best seen in the lateral view of FIG. 4 or in the perspective view of FIG. 6 with the section along the vertical plane X-X (see FIG. 3). The connecting element 12 extends through the vertical hole of the convex area 41d of the linking element 41, and is attached by its lower end to the driving means 10, as can likewise be best seen in FIG. 4.

In the view from above of FIG. 3, a convex area 42f can also be seen as well as a convex area 42g of the die plate 42, which likewise have a vertical through hole or respectively a vertical bore. Extending into and through this vertical through hole is, respectively, one of the two connecting elements 14, 15.

The site of the connecting element 14 and of the connecting element 15 in the view from above lie on a second straight line Y-Y extending in the horizontal direction, i.e. orthogonal to the stroke axis Z-Z and also orthogonal to the first straight line X-X. The connecting element 14 extends through the vertical hole of the convex area 42f of the die plate 42 and is attached by its lower end to the convex area 41a of the linking element 41, as is best seen in the lateral view of FIG. 5 or respectively in the perspective view of FIG. 7 with the section along the vertical plane Y-Y (see FIG. 3). The connecting element 15 extends through the vertical hole of the convex area 42g of the die plate 42 and is attached by its lower end to the convex area 41c of the linking element 41, as is also best seen in FIG. 5.

Shown in FIG. 9 is a perspective exploded view of the elements shown in FIG. 3 to FIG. 8.

One sees the two driving means 9 and 10 operating in the vertical direction Z, the linking element 41 as well as the die plate 42 guided on the guides 5, 6, 7 and 8. Moreover four screws S are shown, to each of which are assigned a washer R and a bushing H. These four screw-washer-bushing combinations S-R-H each form one of the flexible connecting elements 11, 12, 14, 15 mentioned further above, the two flexible connecting elements 11, 12 serving the purpose of flexible connection of the two upper ends of the two driving means 9, 10 to the linking element 41 (see e.g. FIG. 4 and FIG. 6) and the two flexible connecting elements 14, 15 serving the purpose of flexible connection of the linking element 41 to the die plate 42 (see e.g. FIG. 5, FIG. 7 and FIG. 7A). In the mounted state of the device having the driving means 9, 10, the linking element 41 and the die plate 42, the screws S are each tensioned by pulling, i.e. elastically stretched in Z direction, while the washer R and the bushing H are tensioned by pressure, i.e. elastically shortened in Z direction.

Shown in FIG. 10A is a vertical section of a connecting element 11 or 12, shown in more detail, according to a first variant (simple screw with sleeve) of the first embodiment (pin formation), which is disposed in a region between the driving means 9 or respectively driving means 10 and the linking element 41. The screw S thereby projects through a through hole L in the linking element 41 as well as through a bushing H, and is screwed by its lower end or respectively its tip Sa into a threaded bore G on the upper end of the driving means 9 or respectively 10, while the upper end or respectively the head Sb of the screw lies with its shoulder on the washer R, which in turn rests on the upper surface, surrounding the through hole L, of the linking element 41. The bushing H has at its lower end and at its upper end one flange-like enlargement each Ha or respectively Hb, the lower flange-like enlargement Ha resting on an upper surface, surrounding the threaded bore G, of the driving means 9 or respectively 10, and the upper flange-like enlargement Hb abutting a lower surface, surrounding the through hole L, of the linking element 41. The two units thus formed from tensioned screw S, tensioned washer R and tensioned bushing H are clamped between the driving means 9 respectively 10 and the linking element 41, and form the first flexible connecting element 11 or respectively the second flexible connecting element 12.

Shown in FIG. 11A is a vertical section of a connecting element 14 or 15, shown in more detail, according to a first variant (simple screw with sleeve) of the first embodiment (pin formation), which is disposed in a region between the linking element 41 and the die plate 42. The screw S thereby projects through a through hole L in the intermediate plate 42 as well as through the bushing H, and is screwed by its lower end or respectively its tip Sa into threaded bore G on the upper side of the linking element 41, while the head Sb of the screw rests with its shoulder on the washer R, which in turn rests on the upper surface, surrounding the through hole L, of the plate 42. The bushing H has at its lower end and at its upper end in each case the flange-like enlargement Ha or respectively Hb, the lower flange-like enlargement Ha resting on the upper side, surrounding the threaded bore G, of the linking element 41, and the upper flange-like enlargement Hb abutting on a lower surface, surrounding the through hole L, of the die plate 42. The two units thus formed from tensioned screw S, tensioned washer R and tensioned bushing H are clamped between the linking element 41 and the die plate 42, and form the third flexible connecting element 14 or respectively the fourth flexible connecting element 15 of the second configuration (multipoint flexi support/suspension).

Of course the third connecting element 13 of the first configuration (single-point-flexi-support/suspension) can also have the composition described in FIG. 11A. Expediently it would however be dimensioned somewhat bigger than the first connecting element 11 and the second connecting element 12 of this first configuration.

The flexibility of the pin-type connecting elements 11, 12 or respectively 13, 14, 15 shown in FIG. 10A and in FIG. 11A can be adjusted e.g. through the length and/or the wall thickness of the bushing H as well as through the selection of the material of the bushing H. An increase/decrease in the length of the bushing H thereby leads to an increase/decrease in the flexibility of the connecting element. An increase/decrease in the wall thickness of the bushing H thereby leads to a decrease/increase in the flexibility of the connecting element. An increase/decrease in the elastic modulus of the material of the bushing H thereby leads to an increase/decrease in the flexibility of the connecting element.

Shown in FIG. 10B is a vertical section of a connecting element 11 or 12, shown in more detail, according to a second variant (double screw with disk spring) of the embodiment (pin formation), which is disposed in a region between the driving means 9 or respectively the driving means 10 and the linking element 41. A first screw S1 thereby projects through a first through hole L1 in the linking element 41 as well as through a stack of disk springs T and projects with its lower end S1a into a second through hole L2 in an attachment region of the driving means 9 or respectively 10, while the upper end or respectively the head S1b of the first screw S1 rests with its shoulder on a first washer R1, which in turn rests on a second washer R2, which finally rests on the upper surface, surrounding the first through hole L1, of the linking element 41 in an annular cavity. Furthermore a second screw S2 projects into the second through hole L2 in the attachment region of the driving means 9 or respectively 10. The upper end S2a of the second screw S2 is designed sleeve-like, and has in the interior of the sleeve section S2a an inner thread, which is engaged with a complementary outer thread on the cylindrical tip S1a of the first screw S1, while the lower end or respectively the head S2b of the second screw S2 abuts with its should on a counter nut M, which in turn abuts on a third washer R3, which in turn abuts on a fourth washer R4, which finally abuts on the lower surface, surrounding the second through hole L2, of the attachment region of the driving means 9 or respectively 10 in an annular cavity. The disk spring stack T has a function similar to the bushing H of the first variant (see FIG. 10A).

The disk spring stack T has at its lower end a lower disk spring Ta and at its upper end an upper disk spring Tb, which each form with their large annular surface the lower or respectively the upper abutting surface of the disk spring stack T (similar to the flange-type enlargement Ha or respectively Hb of the bushing H in FIG. 10A), the lower disk spring Ta resting on an upper surface, surrounding the second through hole L2, of the driving means 9 or respectively 10 and the upper disk spring Tb abutting on a lower surface, surrounding the first through hole L1, of the linking element 41.

The first screw S1 and the second screw S2 are screwed together in assembled state, the disk spring stack T being compressed in the Z direction. The thus formed two units each contain the two tensioned screws S1, S2, the four tensioned washers R1, R2, R3, R4, the counter nut M and the tensioned disk spring stack T, and are clamped between the driving means 9 or respectively 10 and the linking element 41. They form the first flexible connecting element 11 or respectively the second flexible connecting element 12.

The contact area 81 between the first washer R1 and the second washer R2 as well as the contact area 82 between the third washer R3 and the fourth washer R4 is formed in each case by a pair of spherical surfaces touching each other, and, to be more precise, a concave spherical surface on the first washer R1 and a convex spherical surface on the second washer R2, which both have the same radius of curvature in relation to the common center Z of a fictitious sphere, which is indicated as a broken line in FIG. 10B. Moreover a first annular gap 71 is present between the inner surface of the hole of the second washer R2 and the outer surface of the first screw S1 as well as between the inner surface of the first through hole L1 of the linking element 41 and the outer surface of the first screw S1. Similarly, a second annular gap 72 is also present between the inner surface of the hole of the fourth washer R4 and the outer surface of the second screw S2 as well as between the inner surface of the second through hole L2 at the driving means 9 or respectively 10 and the outer surface of the second screw S2. Between the first washer R1 and the first screw S1 as well as between the third washer R3 and the second screw S2 there is no radial play or a much lesser radial play than in the gap regions 71 and 72.

When assembling the thus formed connecting elements 11, 12 the disk spring stack T is compressed, the respective abutting spherical surfaces of the first washer R1 and of the second washer R2 or respectively of the third washer R3 and of the fourth washer R4 being pressed against each other. The flexibility of the thus formed connecting elements 11, 12 (see FIG. 4 and FIG. 6) is based on the play in the gap regions 71, 72, on the elastic deformability of the disk spring stack T, as well as on the possibility of the sliding on one another of the first and of the second washer R1, R2 in the first contact area 81 as well as on the possibility of the sliding on one another of the third and of the fourth washer R3, R4 in the second contact area 82.

Shown in FIG. 11B is a vertical section of a connecting element 14 or 15, shown in more detail, according to the second variant (double screw with disk spring) of the first embodiment (pin formation), which connecting element is disposed in a region between the linking element 41 and the die plate 42. The first screw S1 thereby projects through a first through hole L1 in the die plate 42 as well as through a disk spring stack T, and projects with its lower end S1a into a second through hole L2 in the attachment region of the linking element 41, while the upper end or respectively the head S1b of the first screw S1 rests with its shoulder on the first washer R1, which in turn rests on the second washer R2, which finally rests on the upper surface, surrounding the first through hole L1, of the die plate 42 in an annular cavity. Moreover the second S2 projects into the second through hole L2 in the attachment region of the linking element 41. The upper end S2a of the second screw S2 is of sleeve-type design, and has in the interior of the sleeve section S2a an inner thread which is engaged with a complementary outer thread on the cylindrical tip S1a of the first screw S1, while the lower end or respectively the head S2b of the second screw S2 abuts with its should on the counter nut M, which in turn abuts on the third washer R3, which in turn abuts on the fourth washer R4, which finally abuts on the lower surface, surrounding the second through hole L2, of the attachment region of the linking element 41 in an annular cavity. The disk spring stack T has a function similar to the bushing H of the first variant (see FIG. 11A).

The disk spring stack T has at its lower end a lower disk spring Ta and at its upper end an upper disk spring Tb, which each form with their large annular surface the lower or respectively the upper face of the disk spring stack T (in a way similar to the flange-type enlargement Ha or respectively Hb of the bushing H in FIG. 11A), the lower disk spring Ta resting on an upper surface, surrounding the second through hole L2, of the linking element 41, and the upper disk spring Tb abutting a lower surface, surrounding the first through hole L1, of the die plate 42.

The first screw S1 and the second screw S2 are screwed together in assembled state, the disk spring stack T being compressed in the Z direction. The thus formed two units each contain the two tensioned screws 51, S2, the four tensioned washers R1, R2, R3, R4, the counter nut M and the tensioned disk spring stack T, and are clamped between the linking element 41 and the die plate 42. They form the third flexible connecting element 14 or respectively the fourth flexible connecting element 15 of the second configuration (multipoint flexi support/suspension).

Of course the third connecting element 13 of the first configuration (single-point flexi support/suspension) can also have the composition described in FIG. 11B. Expediently it would be dimensioned somewhat bigger, however, than the first connecting element 11 and the second connecting element 12 of this first configuration.

The contact area 81 between the first washer R1 and the second washer R2 as well as the contact area 82 between the third washer R3 and the fourth washer R4 is formed in each case by a pair of spherical surfaces touching each other, and, to be more precise, by the concave spherical surface on the first washer R1 and the convex spherical surface on the second washer R2, which both have the same radius of curvature in relation to a common center Z of a fictitious sphere, which is indicated as a broken line in FIG. 11B. Moreover the first gap 71 is present between the inner surface of the hole of the second washer R2 and the outer surface of the first screw S1 as well as between the inner surface of the first through hole L1 of the die plate 42 and the outer surface of the first screw S1. Similarly the second gap 72 is also present between the inner surface of the hole of the fourth washer R4 and the outer surface of the second screw S2 as well as between the inner surface of the second through hole L2 at the linking element 41 and the outer surface of the second screw S2. Between the first washer R1 and the first screw S1 as well as between the third washer R3 and the second screw S2 there is no radial play or a much more minimal radial play than in the gap regions 71 and 72.

During assembly of the thus designed connecting elements 14, 15 the disk spring stack T is compressed, whereby the respective spherical surfaces, resting against one another, of the first washer R1 and of the second washer R2 or respectively of the third washer R3 and of the fourth washer R4 are pressed against one another. The flexibility of the thus formed connecting elements 14, 15 (see FIG. 5 and FIG. 7) is based on the play in the gap regions 71, 72, on the elastic deformability of the disk spring stack T as well as on the possibility of the sliding on one another of the first and of the second washer R1, R2 in the first contact area 81 as well as on the possibility of the sliding on one another of the third and of the fourth washer R3, R4 in the second contact area 82.

The flexibility of the pin-type connecting elements 11, 12 or respectively 13, 14, 15 shown in FIG. 10B and in FIG. 11B can be adjusted e.g. through the overall length of the two screws S1 and S2 and/or the wall thickness of the sleeve section S2a as well as through the selection of the material of the screws S1 and S2. An increase/decrease of the overall length of the screws S1 and S2 thereby leads to an increase/decrease in the flexibility of the connecting element. An increase/decrease of the wall thickness of the sleeve section S2a thereby leads to a decrease/increase in the flexibility of the connecting element. An increase/decrease of the elastic modulus of the material of the screws S1 and S2 thereby leads to an increase/decrease in the flexibility of the connecting element.

The pin-type connecting elements 11, 12 or respectively 13, 14, 15 of the double screw-disk spring type, shown in FIG. 10B and in FIG. 11B, have the advantage, compared to the pin-type connecting elements 11, 12 or respectively 13, 14, 15 of the single-screw-sleeve type, shown in FIG. 10A and in FIG. 11A, that they also make possible an irreversible deformability, in addition to the flexibility based on the mentioned mechanism in the sense of a reversible elastic deformability.

If namely during stress in the form of a tilting effect, the linking element 41 is tilted out of the position, shown in FIG. 10B, relative to the driving means 9 or 10, an elastic deformation of the flexible connecting elements 11, 12 formed by the screws S1 and S2 as well as by the disk spring stack T, takes place up to a maximal value of the tilting effect. With sufficiently great, i.e. supercritical stress (sufficiently great tilting effect), the static friction, at the connecting elements 11, 12, in the first contact area 81 between the first washer R1 and the second washer R2 and/or the static friction in the second contact area 82 between the third washer R3 and the fourth washer R4 is overcome, so that the two washers R1 and R2 and/or the two washers R3 and R4 begin to slide relative to one another. The extent of this sliding movement is limited by the radial play of the gap 71 or respectively of the gap 72. This overcoming of the static friction and the occurrence of sliding with sliding friction in the contact areas 81 and/or 82, creates the irreversible deformation of the connecting elements 11, 12.

Instead of the pin-type first embodiment presented and described with reference to FIG. 10A, FIG. 11A, FIG. 10B, FIG. 11B (cf. FIG. 3) of the flexible connecting elements 11, 12, 14, 15, these elements could also be designed leaf-type, as is shown in FIG. 12, in which these leaf-type flexible connecting elements 11′, 12′, 14′, 15′ are shown in section along a horizontal cutting plane E-E (see FIG. 10C, FIG. 10D, FIG. 11C, FIG. 11D). The depictions in FIG. 10A, FIG. 11A, FIG. 10B, and FIG. 11B would then be vertical sections orthogonal to the plane of the respective leaf-type connecting element, whose leaf plane would extend then in a plane parallel to the stroke axis Z-Z.

The bushing H in FIG. 10A and FIG. 11A would then by replaced by two U-sections, of which the one is open toward the left and the other is open toward the right. This means that the legs of the one U-section extend to the left, and the legs of the other U-section extend to the right, while the base of the two U-sections would be fixed by fixation means (not shown) on the screws or respectively pins S or respectively S1.

The spherical surfaces of the two contact areas 81, 82 in FIG. 10B and FIG. 11B would then be replaced by cylindrical surfaces, the generatrix of which would extend orthogonally to the stroke axis Z-Z, and the annular gaps 71, 72 of FIG. 10B and FIG. 11B would be replaced by planar gaps.

Shown in FIG. 10C is a vertical section of a connecting element 11′ or 12′, shown in more detail, according to a first variant (screwed H section) of the second embodiment (leaf formation), which is disposed in a region between the driving means 9 or respectively the driving means 10 and the linking element 41. An H section P, whose longitudinal axis extends orthogonally to the stroke axis Z-Z, is thereby disposed between the drive element 9 or respectively 10 and the linking element 41 in such a way that two of the four legs of the H section extend to the left and two of these four legs of the H section extend to the right. The lower end Pa of the H section P rests on an upper surface of the driving means 9 or respectively 10, while the upper end Pb of the H section P abuts on a lower surface of the linking element 41. The two legs resting on the driving means 9 or respectively 10 and forming the lower end Pa of the H section are each fixed with a fastening screw 61, which extends through a hole in the respective leg and is screwed into a threaded bore in the driving means 9 or respectively 10. The two legs abutting on the linking element 41 and forming the upper end Pb of the H section are likewise fixed with a fastening screw 61, which extends through a hole in the respective leg and is screwed into a threaded bore in the linking element 41. The plane E-E is the cutting plane along which the connecting elements 11′ and 12′ in FIG. 12 are shown cut.

Shown in FIG. 11C is a vertical section of a connecting element 14′ or 15′, shown in more detail, according to the first variant (screwed H section) of the second embodiment (leaf formation), which is disposed in a region between the linking element 41 and the die plate 42. The H section P, whose longitudinal axis extends again orthogonally to the stroke axis Z-Z, is thereby disposed between the linking element 41 and the die plate 42 in such a way that two of the four legs of the H section extend to the left and two of these four legs of the H section extend to the right. The lower end Pa of the H section P rests on an upper surface of the linking element 41, while the upper end Pb of the H section P abuts on a lower surface of the die plate 42. The two legs resting on the linking element 41 and forming the lower end Pa of the H section are each fixed with a fastening screw 61, which extends through a hole in the respective leg and is screwed into a threaded bore in the linking element 41. The two legs abutting the die plate 42 and forming the upper end Pb of the H section are each likewise fixed with a fastening screw 61, which extends through a hole in the respective leg and is screwed into a threaded bore in the die plate 42. The plane E-E is the cutting plane along which the connecting elements 14′ and 15′ in FIG. 12 are shown cut.

Of course the third connecting element 13 of the first configuration (single-point flexi support/suspension) can also have the composition described in FIG. 11C. Expediently it would be dimensioned somewhat larger, however, than the first connecting element 11′ and the second connecting element 12′ of this first configuration.

Shown in FIG. 10D is a vertical section of a connecting element 11′ or 12′, shown in more detail, according to a second variant (screwed leaf spring) of the second embodiment (leaf formation), which is disposed in a region between the driving means 9 or respectively the driving means 10 and the linking element 41. A leaf spring B, whose longitudinal axis extends orthogonally to the stroke axis Z-Z, is thereby disposed between the drive element 9 or respectively 10 and the linking element 41 in such a way that the leaf plane extends parallel to the stroke axis Z-Z. The lower end Ba of the leaf spring B rests on an upper surface of the driving means 9 or respectively 10, while the upper end Bb of the leaf spring B abuts on a lower surface of the linking element 41. The lower end or respectively the lower edge Ba of the leaf spring B is fixed to the driving means 9 or respectively 10 by means of two clamping strips K1, K2. For this purpose these two clamping strips K1, K2 are each firmly screwed to the driving means 9 or respectively 10 by means of fastening screws 62. Moreover a further fastening screw 63 extends in transverse direction through a respective through hole in the clamping strip K1, in the lower end Ba of the leaf spring B and in the clamping strip K2, this fastening screw 63 at its tip being screwed and firmly tensioned with a fastening nut 64. The upper end or respectively the upper edge Bb of the leaf spring B is fixed by means of two clamping strips K3, K4 to the linking element 41. For this purpose these two clamping strips K3, K4 are each firmly screwed to the linking element 41 by means of fastening screws 62. Moreover here too a further fastening screw 63 extends in transverse direction through a respective through hole in the clamping strip K3, in the upper end Bb of the leaf spring B and in the clamping strip K4, also this fastening screw 63 at its tip being screwed and firmly tensioned with a fastening nut 64. The plane E-E is the cutting plane along which the connecting elements 11′ and 12′ in FIG. 12 are shown cut.

Shown in FIG. 11D is a vertical section of a connecting element 14′ or 15′, shown in more detail, according to a second variant (screwed leaf spring) of the second embodiment (leaf formation), which is disposed in a region between the linking element 41 and the die plate 42. The leaf spring B, whose longitudinal axis extends orthogonally to the stroke axis Z-Z, is thereby disposed between the linking element 41 and the die plate 42 in such a way that the leaf plane extends parallel to the stroke axis Z-Z. The lower end Ba of the leaf spring B rests on an upper surface of the linking element 41, while the upper end Bb of the leaf spring B abuts on a lower surface of the die plate 42. The lower end or respectively the lower edge Ba of the leaf spring B is fixed to the linking element 41 by means of two clamping strips K1, K2. For this purpose these two clamping strips K1, K2 are each firmly screwed to the linking element 41 by means of fastening screws 62 41. Moreover a further fastening screw 63 extends in transverse direction through a respective hole in the clamping strip K1, in the lower end Ba of the leaf spring B and in the clamping strip K2, this fastening screw 63 at its end being screwed and firmly tensioned with a fastening nut 64. The upper end or respectively the upper edge Bb of the leaf spring B is fixed to the die plate 42 by means of two clamping strips K3, K4. For this purpose these two clamping strips K3, K4 are each firmly screwed to the die plate 42 by means of fastening screws 62. Moreover here too a further fastening screw 63 extends in transverse direction through a respective through hole in the clamping strip K3, in the upper end Bb of the leaf spring B and in the clamping strip K4, also this fastening screw 63 at its end being screwed and firmly tensioned with a fastening nut 64. The plane E-E is the cutting plane along which the connecting elements 14′ and 15′ in FIG. 12 are shown cut.

Of course the third connecting element 13 of the first configuration (single-point flexi support/suspension) can also have the structure described in FIG. 11D. Expediently it would be dimensioned somewhat larger, however, than the first connecting element 11′ and the second connecting element 12′ of this first configuration.

Shown in FIG. 12 is a view from above, similar to FIG. 3, of the elements, shown in more detail, of the second configuration according to the second embodiment (see FIG. 10C, FIG. 11C or respectively FIG. 10D, FIG. 11D), the respective connecting elements being shown cut along a horizontal plane E-E. While the pin-type connecting elements 11, 12, 14, 15 of the first embodiment (FIG. 3) are flexible in all directions of the plane X-Y, the leaf-type connecting elements 11′, 12′, 14′, 15′ of this second embodiment (FIG. 12) are practically flexible only for deflections in the X direction, while they have practically no flexibility in the Y direction.

According to the invention, however, both the first embodiment of FIG. 3 with only pin-type connecting elements 11, 12, 14, 15 as well as the second embodiment of FIG. 12 with only leaf-type connecting elements 11′, 12′, 14′, 15′ make possible a torque-free (tilting effect-free) force transmission into the die plate 42 for the case where the two driving means 9 and 10 have a difference in travelling distances extending along the press stroke axis Z-Z.

1. Powder press for producing a pressed piece from a powdered material, with a frame, a punch arrangement and a die arrangement, which defines a die cavity into which the powdered material is fillable and afterwards the punch arrangement and the die arrangement are movable relative to one another along a vertical press stroke axis Z-Z and are pressible against one another to form the pressed piece, whereby
a) the die arrangement has a die plate linking element connected to two drive means acting parallel along the vertical axis Z-Z and a die plate guided along the stroke direction or respectively vertical axis Z-Z on guide means and connected to the die plate linking element; and
b) the die plate linking element is connected to a first said drive means by means of a first flexible connecting means and to a second said drive means by means of a second flexible connecting means, the first connecting means as well as the second connecting means being disposed on a first straight line X-X orthogonal to the vertical press stroke axis Z-Z; and
c) the die plate linking element and the die plate are connected to one another by means of a third flexible connecting means which is disposed on a second straight line Y-Y orthogonal to the vertical press stroke axis Z-Z and orthogonal to the first straight line X-X in a way equidistant to the first flexible connecting means and the second flexible connecting means in such a way that the resulting tractive force or thrusting force transmitted by the third flexible connecting means is introduced into the die plate at a point on a vertical straight line running through the center of gravity of the die plate,
wherein
d) on the one hand:
the first flexible connecting means has a first flexible connecting element fixed to the first drive means and to the die plate linking element; and
the second flexible connecting means has a second flexible connecting element fixed to the second drive means and to the die plate linking element; and
e) on the other hand:
e1) the third flexible connecting means has a third flexible connecting element fixed to the die plate linking element and to the die plate; or
e2) the third flexible connecting means has a third flexible connecting element fixed to the die plate linking element and to the die plate and a fourth flexible connecting element fixed to the die plate linking element and to the die plate.

2. Powder press, in particular according to claim 1, for producing a pressed piece from a powdered material, with a frame, a punch arrangement and a die arrangement which defines a die cavity into which the powdered material is fillable and afterwards the punch arrangement and the die arrangement are movable along a vertical press stroke axis Z-Z relative to one another and are pressible against one another to form the pressed piece, whereby
a′) the punch arrangement has a punch plate-linking element connected to two drive means acting parallel along the vertical axis Z-Z and a punch plate guided along the stroke direction or respectively vertical axis Z-Z on guide means and connected to the punch plate-linking element; and
b′) the punch plate-linking element is connected to a first said drive means by means of a first flexible connecting means and to a second said drive means by means of a second flexible connecting means, the first connecting means as well as the second connecting means being disposed on a first straight line X-X orthogonal to the vertical press stroke axis Z-Z; and
c′) the punch plate-linking element and the punch plate are connected to one another by means of a third flexible connecting means, which is disposed on a second straight line Y-Y orthogonal to the vertical press stroke axis Z-Z and orthogonal to the first straight line X-X in a way equidistant to the first flexible connecting means and to the second flexible connecting means in such a way that the resulting tractive force or thrusting force transmitted by the third flexible connecting means is introduced into the punch plate at a point on a vertical straight line running through the center of gravity of the punch plate,
wherein
d′) on the one hand:
the first flexible connecting means has a first flexible connecting element fixed to the first drive means and to the punch plate linking element; and
the second flexible connecting means has a second flexible connecting element fixed to the second drive means and to the punch plate linking element; and
e′) on the other hand:
e1′) the third flexible connecting means has a third flexible connecting element fixed to the punch plate linking element and to the punch plate; or
e2′) the third flexible connecting means has a third flexible connecting element fixed to the punch plate linking element and to the punch plate and a fourth flexible connecting element fixed to the punch plate linking element and to the punch plate.

3. Powder press according to claim 1, wherein the third flexible connecting means has the third flexible connecting element fixed to the die plate linking element and to the die plate, the third flexible connecting element being fixed to the die plate linking element or at a linking element attachment site 0/0/Z1 situated on the vertical axis Z-Z, and the third flexible connecting element being fixed to the die plate at a plate attachment site 0/0/Z2 situated on the vertical axis Z-Z.

4. Powder press according to claim 1, wherein the third flexible connecting means has the third flexible connecting element fixed to the die plate linking element and to the die plate and the fourth flexible connecting element, the third flexible connecting element being fixed to the die plate linking element at a first linking element attachment site 0/Y4/Z 1, and the fourth flexible connecting element being fixed to the die plate linking element at a second linking element attachment site 0/Y5/Z1, and the third flexible connecting element being fixed to the die plate at a first plate attachment site 0/Y4/Z2 and the fourth flexible connecting element being fixed at a second plate attachment site 0/Y5/Z2, the linking element attachment sites 0/Y4/Z1 and 0/Y5/Z1 being situated on a second straight line orthogonal to the vertical axis Z-Z and orthogonal to the first straight line X-X, and the plate attachment sites 0/Y4/Z2 and 0/Y5/Z2 being situated on a third straight line orthogonal to the vertical axis Z-Z and to the first straight line X-X.

5. Powder press according to claim 1, wherein one or both of the first flexible connecting element and the second flexible connecting element are each formed by a pin-type element or leaf-type element elastically tensioned parallel to the vertical axis Z-Z, which pin-type or leaf-type element extends through a respective through hole of the linking element, a first end of the respective pin-type element or leaf-type element being connected to a respective said first drive means or said second drive means and a second end of the respective pin-type or leaf-type element being connected to the linking element.

6. Powder press according to claim 5, wherein one or both of the first flexible connecting element and the second flexible connecting element are each a screw/spacer unit, whose respective spacer is clamped between the facing sides of the respective said first drive means or said second drive means and of the linking element by means of the respective screw and surrounds the screw in a ring-like or sleeve-like way, the respective screw extending through the respective through hole of the linking element, a first end the respective screw being screwed into a threaded bore of the respective said first drive means or said second drive means and a second end, designed as screw head, of the respective screw abutting the linking element in the region of the through hole.

7. Powder press according to claim 5, wherein one or both of the first flexible connecting element and the second flexible connecting element are each made up of a spring leaf unit whose respective spring leaf, which is a leaf-type spacer, extends in a plane orthogonal to the first straight line X-X, a first end of the respective spring leaf being firmly connected to the respective said first drive means or said second drive means and a second end of the respective spring leaf being firmly connected to the linking element.

8. Powder press according to claim 6, wherein one or both of the first flexible connecting element and the second flexible connecting element are spherically borne at least at one of their ends.

9. Powder press according to claim 7, wherein one or both of the first flexible connecting element and the second flexible connecting element are cylindrically borne at their lower end and/or at their upper end, the cylinder axis or respectively rotational axis of the support extending parallel to the straight line Y-Y.

10. Powder press according to claim 1, wherein one or both of the third flexible connecting element and the fourth flexible connecting element are each formed by a pin-type element or a leaf-type element elastically tensioned parallel to the vertical axis Z-Z, which pin-type or leaf-type element extends through a respective through hole of the die plate, a first end of the respective pin-type element or leaf-type element being connected to the linking element and a second end of the respective pin-type or leaf-type element being connected to the die plat.

11. Powder press according to claim 10, wherein the one or both of the third flexible connecting element and the fourth flexible connecting element are each a screw/spacer unit, whose respective spacer is clamped between the facing sides of the die plate or and of the linking element by means of the respective screw and surrounds the screw in a ring-like or sleeve-like way, the respective screw extending through the respective through hole of the die plate, a first end of the respective screw being screwed into a threaded bore of the linking element and a second end, designed as screw head, of the respective screw abutting on the die plate in the region of the through hole.

12. Powder press according to claim 10, wherein the one or both of the third flexible connecting element and the fourth flexible connecting element are each formed by a spring leaf unit, whose respective spring leaf extends in a plane orthogonal to the first straight line X-X, a first end of the respective spring leaf being firmly connected to the linking element and a second end of the respective spring leaf being firmly connected to the die plate.

13. Powder press according to claim 11, wherein the one or both of the third flexible connecting element and the fourth flexible connecting element are spherically borne at least at one of their ends.

14. Powder press according to claim 12, wherein the one or both of the third flexible element and the fourth flexible connecting element are cylindrically borne at their lower end and/or at their upper end, the cylinder axis or respectively rotational axis of the support extending parallel to the straight line Y-Y.

15. Powder press according to claim 1, wherein the stiffness or respectively flexibility of the first flexible connecting means, the second flexible connecting means or the third flexible connecting means is adjustable.

16. Powder press according to claim 2, wherein the third flexible connecting means has the third flexible connecting element fixed to the punch plate-linking element and to the punch plate, the third flexible connecting element being fixed to the punch plate-linking element at a linking element attachment site 0/0/Z1 situated on the vertical axis Z-Z, and the third flexible connecting element being fixed to the punch plate at a plate attachment site 0/0/Z2 situated on the vertical axis Z-Z.

17. Powder press according to claim 2, wherein the third flexible connecting means has the third flexible connecting element fixed to the punch plate linking element and the punch plate and the fourth flexible connecting element, the third flexible connecting element being fixed to the punch plate linking element at a first linking element attachment site 0/Y4/Z1, and the fourth flexible connecting element being fixed to the punch plate linking element at a second linking element attachment site 0/Y5/Z1, and the third flexible connecting element being fixed to the punch plate at a first plate attachment site 0/Y4/Z2 and the fourth flexible connecting element being fixed at a second plate attachment site 0/Y5/Z2, the linking element attachment sites 0/Y4/Z1 and 0/Y5/Z1 being situated on a second straight line orthogonal to the vertical axis Z-Z and orthogonal to the first straight line X-X, and the plate attachment sites 0/Y4/Z2 and 0/Y5/Z2 being situated on a third straight line orthogonal to the vertical axis Z-Z and to the first straight line X-X.

18. Powder press according to claim 2, wherein one or both of the third flexible connecting element and the fourth flexible connecting element are each formed by a pin-type element or a leaf-type element elastically tensioned parallel to the vertical axis Z-Z, which pin-type or leaf-type element extends through a respective through hole of the punch plate, a first end of the respective pin-type element or leaf-type element being connected to the linking element and a second end of the respective pin-type or leaf-type element being connected to the punch plate.

19. Powder press according to claim 18, wherein the one or both of the third flexible connecting element and the fourth flexible connecting element are each a screw/spacer unit, whose respective spacer is clamped between the facing sides of the punch plate and of the linking element by means of the respective screw and surrounds the screw in a ring-like or sleeve-like way, the respective screw extending through the respective through hole of the punch plate, a first end of the respective screw being screwed into a threaded bore of the linking element and a second end, designed as screw head, of the respective screw abutting on the punch plate in the region of the through hole.

20. Powder press according to claim 18, wherein the one or both of the third flexible connecting element and the fourth flexible connecting element are each formed by a spring leaf unit, whose respective spring leaf extends in a plane orthogonal to the first straight line X-X, a first end of the respective spring leaf being firmly connected to the linking element and a second end of the respective spring leaf being firmly connected to the punch plate.
